(19) United States
(12) Patent Application Publication
(10) Pub. No.: US 2018/0075721 A1
(43) Pub. Date: Mar. 15, 2018

(54) CONDITIONAL SEPARATION ALERT SYSTEM

(71) Applicants: Ian James Oliver, Kambah (AU); Stephen Edward Ecob, Chatswood West (AU)

(72) Inventors: Ian James Oliver, Kambah (AU); Stephen Edward Ecob, Chatswood West (AU)

(21) Appl. No.: 15/810,064

(22) Filed: Nov. 12, 2017

Related U.S. Application Data
(63) Continuation-in-part of application No. 14/556,151, filed on Nov. 30, 2014, now Pat. No. 9,854,385.

(30) Foreign Application Priority Data
Nov. 29, 2013 (AU) 2013904636
Nov. 29, 2013 (AU) 2013904637
May 15, 2014 (AU) 2014901806
May 15, 2014 (AU) 2014901807

(51) Int. Cl. G08B 13/24; G08B 13/14; G08B 21/02; H04W 4/02; H04W 4/00; G01S 5/02

(52) U.S. Cl. CPC G08B 13/2462; G08B 13/2482; G08B 13/1427; G01S 5/02; G08B 13/1436; H04W 4/023; H04W 4/005; G08B 21/0227

(57) ABSTRACT

A system for detecting and reporting the separation of two entities including where the entities are people or items. In some implementations, the system performs separation checking triggered by movement conditions, or by checking of the state of an entity upon separation, and additionally adapts checking methods according to a condition.

### CROSS REFERENCE TO RELATED APPLICATIONS

This application claims priority and is a continuation-in-part application of U.S. Non-Provisional application Ser. No. 14/556,151, filed Nov. 30, 2014, which claims priority to Australian Provisional Patent Application No. 2013904637, filed on Nov. 29, 2013, entitled LOSS PREVENTION DEVICE, and Australian Provisional Patent Application No. 2014901806, filed on May 15, 2014, entitled LOSS PREVENTION DEVICE, and Australian Provisional Patent Application No. 2013904636, filed on Nov. 29, 2013, entitled UV RADIATION PROTECTION SYSTEM, and Australian Provisional Patent Application No. 2014901807, filed on May 15, 2014, entitled UV RADIATION PROTECTION SYSTEM, which are hereby incorporated by reference in their entirety.

### TECHNICAL FIELD

The subject matter disclosed herein generally relates to detecting and reporting the separation of two entities including where the entities are people or items. Specifically, the present disclosure addresses systems and methods to perform separation checking triggered by movement conditions and checking of the state of an entity upon separation. As well as adapting checking methods according to a condition.

### BACKGROUND

In our busy lives it is easy to forget items that we need during the day such as umbrellas, hats, bags and sunscreen as a few examples. It is inconvenient to have to return home or to another location such as an office to pick them up. When we are leaving a location like a house it is also inconvenient to always check predicted weather conditions such as UV levels which would necessitate taking sunscreen, hats, sunglasses or umbrellas etc. If possessions are left at locations where there is a high risk of another party taking or stealing the possession then there may be a need to warn the user very quickly, depending on the level of risk of the location. Ideally the user should be warned as soon as they have left the area or are in the process of leaving the area. Some present solutions exist that provide a mechanism to locate items that have been lost, but this is inadequate because as soon as an item has been left in an area of high risk the item may be stolen or moved. Such methods also rely on there being other monitoring to locate the device, which will not always be available, and so will limit the utility of that approach.

If the user and the possession are in the same area of risk it may not be case that the user leaves the area while the possession remains, it may instead be the case that the possession leaves the area, for example because a thief takes the possession away. An example of this may be when the thief takes a bag away from the proximity of the user. If the user and the possession are in the same area of risk and the possession is moved or touched whilst staying within the area of risk then it would be desirable for the user to be alerted. For example, the possession may be a bag with a pocket with a zip closing the pocket. If the user and the bag are both at an airport (where the user may be easily distracted and thus not noticing someone opening the zip, perhaps while his back is turned concentrating on ticket reservations) then it would be desirable for the user to be warned if the zip is opened. Depending on the risk level of the area or time of day, while the bag is in the area there may be a need to also warn if the bag is even moved slightly, indicating the very beginning of a theft. It would be helpful if the monitoring could be automatically started or the user might require monitoring to start even without personally realising that the area is risky.

The user may sometimes need to leave a possession in a risk area where actuation of an entity, such as attempted operation of a lock or movement of a bike, should be enough to alert the user. In some high risk areas even approaching the entity might warrant warning. Power considerations should be balanced so that the small devices using Bluetooth Low Energy processors or similar devices minimise the amount of transmitting they perform to extend the life of the small batteries they use. It is the object of the present invention to fulfil these needs.

### SUMMARY

A system which provides various situational based warnings on the state of possessions relative to a moving, mobile user or fixed monitoring point is provided. The disclosed system may also be used to protect persons such as dependent children, so throughout the balance of this document possessions, persons and other objects requiring protection shall be referred to as “entities”.

The system is provided as follows. The user has a mobile computing device 102 and one or more entity detection devices 110 attached to entities such as Umbrellas 131, sunscreen 133, children 132, bags 299 and bikes 150. The entity detection devices 110 can be temporarily or permanently attached and may also be replaceable. Radio communication using (but not limited to) Bluetooth Low Energy (Bluetooth 4) is used to determine the proximity and the presence of an entity. The radio communication is also used to transmit information, such as whether an event occurs. An examples of an event is the movement or opening of a bag 299 as indicated by an accelerometer 118, gyroscope 119, contact switches, potentiometers, magnetometers, Passive Infrared (PIR) sensor or any other type of sensor.

The behavior of the entity detection device 110 and mobile computing device may vary according to characteristics of the current position and/or states of a person or entity causing a multiplicity of different warnings and alerts to be generated according to the said position and states.

Potential positions and/or states the system may enter include but are not limited to: First, the movement or transition of user and mobile computing device between various areas zone, for example between 100 and 120, but the entity and associated or attached entity detection device 110 is left behind. Second, transition between areas or times of various different risk levels requiring the frequency of communication connections between 102 and 110 to be increased for higher risk areas to provide prompt warnings if entity and user are separated. Third, the movement of entity and associated entity detection device 110 as detected by accelerometer and/or gyroscope 119 potentially as the entity is being separated from the user. Fourth, the changed state of the entity as detected by the attached entity detection device 110, such as the opening of a bag 299 or other events causing the user's mobile computing device to alert the user

Fifth, the movement of person as measured by a mobile computing device's accelerometer 118 relative to an entity as measured by the entity detection device and warning the user that the entity may be left behind. Sixth, the transition of the user and his mobile computing device out of the area but another mobile computing device 102 performing the same role or monitoring and optionally also in a fixed position termed a “hub” 109. A hub 109 is a mobile computing device 102 in a fixed position (and optionally also moveable). The hub 109 can receive and transmit to the area 120. Seventh, an entity detection device or Mobile Computing Device 102 may be out of range of each other to receive signals, indicating separation. Eighth, an entity detection device or Mobile Computing Device 102 may be in range of each other and able to receive Radio Signal Strength Indication (RSSI) data but warning if the signal is weak, indicating distance has increased to some threshold.

Warnings or alerts can be issued from the phone and/or device and/or sent to a multiplicity of receivers such as the phone of the user or the entity detection device 110 and remote users such as security personnel, parents or teachers. The warning can also be displayed by other local devices such as an alarm device or security hub device. The battery usage of the Entity Detection Device 110 is very important to the utility of the invention, as it may not be convenient to recharge or replace the battery. As much processing burden as possible is placed on the Mobile Computing Device 102 to do the more energy consuming activities. The term “polls” is used to indicate checking by radio listening or radio transmitting at a set frequency.

Examples of monitoring mode strategies to detect distance and other event in a battery conservative situation include: Firstly, the entity detection device 110 polls by listening for the regularly transmitting Mobile Computing Device 102 with a frequency appropriate to the risk situation.

Secondly, the device responds the first time it is polled by Mobile Computing Device 102 or Mobile Computing Device 102 changes poll time and thereafter the device only transmits when it loses or the signal from the Mobile Computing Device 102 falls below a certain level or an event is occurs which the devices wishes to communicate to the Mobile Computing Device 102. Optionally no response the first time or on poll time changes is required.

Thirdly, the entity detection device sends messages to the Mobile Computing Device 102 when an event occurs such as the movement of the bags 299. Fourthly, when the entity is moving and the risk is high then the pairing/bonding can be used to ensure that it can keep in regular communication and respond rapidly to distance separation. Fifthly, the entity device turns on at a time as hinted or told by the user for periods of time to monitor or synchronise to any nearby Mobile Computing Device 102 to monitor for events or report to Mobile Computing Device 102 any previously collected and stored information.

### BRIEF DESCRIPTION OF THE DRAWINGS

The invention may be better understood with reference to the illustrations of the embodiments of the invention, in which:—

FIG. 1 shows a system for detecting if an entity detection device 110 (and therefore the object it is connected to) becomes displaced from the user.

FIG. 2 shows the connection of contacts to an entity detection device 110 attached to a bag 299 allowing detection of the opening of the bag 299.

FIG. 3 shows the user interface designs provided to allow definition of geographical zones or areas and configuration of their attributes.

FIG. 4 shows example travel paths or routes and the modes in which the system operates on the various described paths.

FIG. 5 shows example configurations stored in a database either on the mobile computing device or remote server.

### DETAILED DESCRIPTION

### First Embodiment

Potential positions and/or states the system may enter include but are not limited to;

First, the movement or transition of user and mobile computing device 102 between various areas zone but the entity and associated or attached entity detection device is left behind and optionally the entity detection device is required because of situations such as weather causing a warning that the entity is required and should not be left behind. Second, transition between areas or times of various different risk levels requiring changes in the connection frequency between the entity detection device 110 and mobile computing device 102 to be increased for higher risk areas so that the mobile computing device 102 and/or entity detection device 110 can warn the user more promptly in high risk zones if the entity and user are being separated as may happen during theft of an entity.

Third, the movement of entity and associated entity detection device as detected by acceleration and/or gyroscope 119 of the attached entity detection in areas of varying risk levels such as at an airport with higher chance of bags 299 theft. Fourth, the change state of the entity as detected by the attached entity detection device such as the opening of a bags 299 causing the user's mobile computing device to alert the user. Change of state may be an event a panic button operated, PIR detecting a person, bags 299 opened by zip or any such input such as contact switches sensors including but not limited to those used for security systems.

Fifth, the movement of person as measured by a mobile computing device's accelerometer 118 relative to an entity as measured by the entity detection device 110 (by its accelerometer) and warning the user of the potential leaving behind of an item as the user moves and an a wanted object remains un moved. Such a scenario involves for example a user 101 standing up form a seat where an Umbrella 131 (with attached Entity Detection Device 110) was also lying next to the user on the seat. The user moves away from the seat without picking up the Umbrella 131, leaving the Umbrella 131 behind on the bus 155. When the mobile computing device detects movement and communication 153 with entity detection device 110 attached to the umbrella indicates that the umbrella was not moved then the mobile computing device can warn the user. The sensing of movement can be extended from acceleration to include gyroscope 119, compass and also from this information path movements providing a more detail analysis and inference of the kind of movement as well as difference between the movements. The monitoring of acceleration differences can always be on, turned on for zones, or when there has been travel data indicating moving following by stopping by a vehicle as the following moment may be the occasions when item left behind.

Sixth, the transition of the user and his mobile computing device out of the area but another mobile computing device performing the same role and optionally also in a fixed position termed a “hub” 109 automatically or manually takes on the monitoring of the position and/or state of entities and associated entity detection device 110 such as Child 132 with entity detection device 110 operating as a warning bracelet or an entity detection device attached to a a bike 150. When the position or state of the entity changes, the user can be alerted when in range of the hub's low power RF or remotely if the hub 109 can communicate over a fixed or mobile internet network.

Seventh, an entity detection device or Mobile Computing Device 102 may be out of range of each other to receive signals indicating separation. Eighth, an entity detection device or Mobile Computing Device 102 may be in range of each other to receive signals radio proximity signal strength RSSI (Radio Signal Strength Indicator) but of varying weaknesses and hence an estimate of distance including near by through to almost out if range. Deteriorating signal strength can be used to alert a user before the entity detection device is no longer contactable and the entity no possible to track and potentially lost. For example, the Mobile Computing Device 102 transmits a signal of known strength, the Entity Detection Device 110 is programmed to detect the signal when it falls below a set level where the level indicates a distance that still allows the Entity Detection Device 110 at a same or stronger level to respond to the Mobile Computing Device 102 to say the distance has exceeded a specified safe range. The distance and hence transmission and threshold signal strengths can be adaptable according to the area or zone.

The kinds of warnings or alerts can be issued from the phone and/or device and/or sent to multiplicity of receivers such as the phone of the user or the entity detection device and remote users such as security, parent, teacher. The warning can also be displayed by other local devices such as alarm device, security hub device

The battery usage of the Mobile Computing Device 102 (which can however often be recharged) but particularly the Entity Detection Device 110 (which can mostly not have the battery recharged and is desirable often not to replace) is very important to the utility of the invention. If the battery usage of the non rechargeable Entity Detection Device 110 is minimised the battery will last long enough that the device may be available for almost same amount of time as battery's shelf life and may even potentially be sealable in one unit.

The emphasis can be given on placing as much burden as possible on the Mobile Computing Device 102 to do the most more energy using transmission and where possible, compared to relatively less energy consuming radio listening and receiving with the entity detection device in the again lower power consumption sleep state for as long as possible being woken up by a timer or Input/Output. The Conservation of energy, especially on Entity Detection Device 110, is affected by the connection frequency between devices as well as the amount of time spent in sleep state. Listening and receiving can take less energy than transmitting by a 33 percent reduction or more. Allowing the Entity Detection Device 110 to enter sleep mode with a timer or Input/Output to wake up is very efficient for the Entity Detection Device 110 whereas bonding or pairing is least favoured for energy consumption but important when devices need to exchange information, compare data without waiting for the establishment of a connection because a quick response time is required. Pairing or bonding is generally a much higher polling/connection rate between device being often at least every 10 seconds.

Given these energy consumption considerations, a various different strategies varying the connection time, and polling frequency between the Mobile Computing Device 102 and Entity Detection Device 110 can be optimised in the following ways so that where possible the Entity Detection Device 110 sleeps as long as possible with optimum polling frequency which still allows depending on the risk of the environment and importance of the equipment to which the Entity Detection Device 110 is connected to protect and monitor where possible minimising transmission and receiving power usage but also allows checking which is frequent enough to notice events such as loss or diminishing of signal or data sent which may indicate that the entity is moving away or being tampered with such as being opened. As one example of optimisation for battery conservation the Entity Detection Device 110 has a timer set for Umbrellas 131 and sunscreen 133 so that the user doesn't need to remember to take at night when it would be a waste of time to turn on monitoring.

Broadly, Polling is the process of one device transmitting a signal at a set frequency to which a second device may receive. The second device may be designed to respond to the first device, each time polled when it receives the signal to indicate to the first device that it is still present as one example, where the response may consist of data also to communicate. A disadvantage of polling is second device needs to be listening and also the first needs to transmit regularly without being aware if there is any need. Polling can be optimised by having the agreed synchronisation time bands using synchronised clocks where the process occurs with both devices sleeping at other times. The synchronisation time can be varied.

Polling can also alternatively be the process of listening for an expected or in case a signal may be set at set frequencies and times for a second device. A given device can both simultaneously perform both transmitting and receiving polling. In another variation the second device only responds when it has information to send, reducing the need for transmission.

The second device could also tell the first device to stop monitoring when it is about to leave the zone where it can communicate to allow the first device to stop monitoring. An alternative approach is event based involving the first device listening for the second to transmit when an event occurs such as the movement of the bags 299. This does however require the first device to be listening often (though again synchronisation strategies can also be used) but means that depending on the event being monitored this can be combined with timed synchronised checking so that the first device does not need to be listening all the time. Operating systems such as iOS7 monitor for Bluetooth Low Energy signal related events to be triggered by the locationManager depending on the detection (didEnterRegion) and loss of signals (didExitRegion)

Some non limiting examples of monitoring mode strategies to detect distance and other event in a battery conservative situation include:

Firstly, the entity detection device 110 polls by listening for the regularly transmitting Mobile Computing Device 102 with a frequency appropriate to the risk situation listening with a polling frequency which is in synchronisation to the Mobile Computing Device 102 polling transmitting from Mobile Computing Device 102 then the Entity Detection Device 110 transmits a response every time it is polled or every certain number of times, from which the Mobile Computing Device 102 or Entity Detection Device 110 can calculate the signal strength such as RSSI and so distance and take any required action as configured by the system such as reporting if the distance exceeds some amount.

The transmission by the Mobile Computing Device 102 can always be on or it can be optimised to poll in at times synchronised with an extra error range also configured. If the transmission is on then if for example the Entity Detection Device 110 detects movement it does not need to wait polling frequency before reporting.

As the Mobile Computing Device 102 moves into areas or Entity Detection Device 110 increased acceleration with increased risk it can communicate to the Entity Detection Device 110 to increase the polling frequency.

Secondly, the Entity Detection device 110 starts monitoring from the first time it is polled by Mobile Computing Device 102 and when the signal is lost or below certain level or event occurs it alerts the Mobile Computing Device 102 while it can still respond to the Mobile Computing Device 102 because it is in range. The transmission strength of the Mobile computing device 110 and/or the threshold after which to consider the signal it too low or distance should be set so that when the level is reached, the Entity Detection Device 110 has sufficient transmission strength to be able to contact the Mobile Computing Device 102 and alert. While this method has the advantage that the Entity Detection Device 110 listening mostly with little transmission, but relies on assumption that the Entity Detection Device 110 will always have an opportunity to respond before being out of range. Optionally the Entity Detection Device 110 may also transmit to warn the Mobile Computing Device 102 if the Entity Detection Device 110 moves near to another fixed or variable Mobile Computing Device 102 and moves close in range used to indicate the outer perimeter of a safe are mean time assume it is ok.

The Entity Detection Device 110 can optionally responds the first time it is polled by Mobile Computing Device 102 or when the Mobile Computing Device 102 changes poll time.

The system can also be designed so that unless the Entity Detection Device 110 transmits and until the Entity Detection Device 110 detects that it has left or is leaving the receiving range of the Mobile Computing Device 102 the Entity Detection Device 110 is present and monitoring, has not responded presently as nothing to report but will transmit if an event occurs.

Thirdly, the entity detection device send messages to the Mobile Computing Device 102 when an event occurs such as the movement of the bags 299. The Entity Detection Device 110 detection device can be in sleep mode until the accelerometer 118 detects movement and then transmits the event. The Mobile Computing Device 102 needs to be able to listen for such events. For example, in the case of iOS operating system, the LocationManager:didEnterRegion can be used by the software to detect a signal is sent by the entity detection device.

Circuitry such as capacitance and/or counters and timers can be used to monitor for a certain amount of movement before waking up the Entity Detection Device 110.

Fourthly, when entity is moving or can be moved quickly measured by the accelerometer 118 and/or the Mobile Computing Device 102 using position information such as GPS that the risk is high then the pairing (bonding) can be used to give immediate communication access between the devices. Fifthly, the entity detection device turns on at a time as hinted or told by the user for periods of time to find time to monitor or synchronise to any nearby to monitor for events or collecting previously collected and stored information. Sixthly, the separation of an entity and associated transmitting entity detection device from a mobile computing device 102 can be detected by event handlers in the software in the mobile computing device after the devices have come in range of each other, for example, as detected for iOS by the locationManager:didEnterRegion event, by the monitoring on the mobile computing device of the event of the loss of signal event, for example, as detected for iOS by the locationManager:didExitRegion.

Seventhly, the presence of an entity or information communicated by an associated entity detection device transmitting can be detected by event handlers in the software in the mobile computing device 102 for example, as detected for iOS by the locationManager:didEnterRegion event, by the monitoring on the mobile computing device of the event of the loss of signal event, for example, as detected for iOS by the locationManager:didExitRegion. Eight, the entity detection device pairs with the mobile computing device when the mobile computing device is detected and remains paired or alternatively, the entity detection device periodically polls by transmitting to mobile computing device so that the mobile computing device can calculate its distance and receive any information from the entity detection device. This uses more battery on the entity detection device particularly depending on the polling frequency for transmission from the entity detection device.

As an alternative to the use of radio signals and the calculation of signal strength and from this then estimation of distance, physical sensors including but not limited to accelerometers, compass and gyroscope 119 as well as other sensors that can add can be used to augment the accuracy of these distance measurement taken from radio waves or used instead. These physical sensors can also be used to completely replace the use of radio based distance estimation. For example, in the example of the case of the movement of a bags 299 the physical movements can be used estimate and detect if a bags 299 has been moved by detecting sustained paths and paths of certain characteristics indicating movement. These paths may consist of a vector of measurements which may be pre recorded paths to identify as indicating events such as the lifting of a bags 299, standing up or sitting down of a person as a few non limiting example. Paths may also be specifically matched to a location or starting or ending position. For example, in the case of the detection of shop lift/shop theft the system know it's starting position for example by being programmed or acquiring this from internal positioning IPS using for example low power RF beacons such as bluetooth or GPS may use the physical sensor system to estimate it's new location as it is moved and optionally also using map or other information deduce it's new position and if for example the new position required a warning to be generated for example perhaps indicating being near the exit door indicate that as the device has not been removed by a sales assistant a theft is occurring.

In this case of leaving the house, a user's regular movements of accelerations, compass and gyroscope 119 and IPS path calculation can be used combined with events such as the loss of a WiFi connection or bluetooth beacons, or other networks detected by the Mobile Computing Device 102 or the acquisition of GPS indicating outside or reliable, consistent acquisition, and/or movements indicative of moving in a vehicle or walking combined with time can be used to determine if the user has left the house or any other zone. If the act of leaving the house is detected, the mobile computing device 102 can check if the Entity Detection Device 110 can be connected to, and/or, the separation distance using Bluetooth Low Energy functionality or other RF technology. In this way, as the entity detection device 110 is attached to entities that are required by the user when leaving home such as a hat 134, sunscreen 133, Umbrella 131 this system can remind the user to take them if they are about to leave them behind.

Additionally, checks can be done to determine if an Entity Detection Device 110 is present in the house early. Additionally, Mobile Computing Device 102 can contact and monitor for the Entity Detection Device 110 and when the signal goes out of range this can also be used to determine of the Entity Detection Device 110 is being let behind. This indicator of potentially leaving behind the Entity Detection Device 110 can be combined with other described indicators that the user has left the house or other zones. The kind of movement such as identification of movement in different forms of transport for example car or bus and whether walking and at what speed can be deduced and used to determine the risk level and hence polling frequency. In addition to locations, areas and zone where different levels of risk can be assigned the activity or mode of transport a person currently using or experiencing can be used to assign risk factors

The sensors can be positioned on the entity detection device and the Mobile Computing Device 102 in a multiplicity of orientations and in any number to calculate as physical properties in all directions and angles.

GPS and other forms of positioning can also be used to the kind of activity or transport some one is current experiencing. For example the speed of movement may indicate, or path and these used to determine a risk level and hence monitoring modes and polling frequency appropriate to the situation.

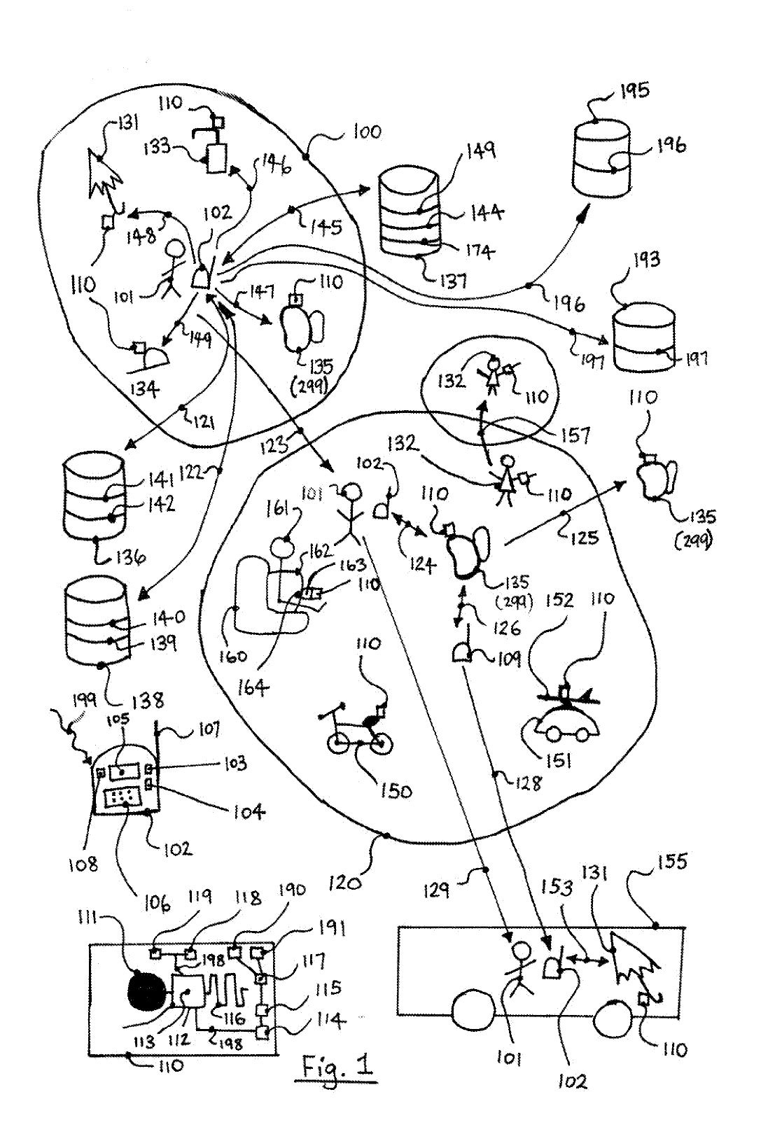

Referring to FIGS. 1, 2, 3, 4 and 5:—

A mobile computing device 102 consisting of a processor and radio 103, software 104, display 105, keyboard 106, antenna 107 and accelerometer/gyroscope 108. Functions described in this disclosure involve information being sent, received or processed may be implemented by the software 104. The processor and radio and antenna shall be able to communicate in or by, but not limited to, low power RF such as Bluetooth, and Bluetooth Low Energy (Bluetooth 4) as well as be able to communicate using other forms of WiFi, mobile network communication, internet, SMS, and wire and cable as some non limiting examples. The Mobile Computing Device 102 also includes a battery. Example mobile computing devices 102 can include but are not limited to iPhone, Android, Smart Watches, Tablets, laptops and the like.

The mobile computing device 102 can transmit and receive from an area 100.

Functions described in this disclosure involve information being sent, received or processed may be implemented by the software 104. The processor and radio and antenna shall be able to communicate in but not limited to low power RF such as Bluetooth, and Bluetooth Low Energy (Bluetooth 4). The Mobile Computing Device 102 also includes a battery. Example mobile computing devices 102 can include but are not limited to iPhone, Android, smart watches, tablets, laptops and the like.

The mobile computing device 102 can also be iWatch, smart watch, iPhone, iPod, iPod, tablet, Android, Windows or other operating system based device or other such devices. An individual or group may own a set of these and wish for them to be kept from being lost.

Software in the Entity Detection Device 110 and Mobile Computing Device 102 as an application that can run in foreground and background can perform operations described to implement the monitoring modes and alerts and other computations. The mobile computing device 102 also contains a battery which may also be recharged by connection to a mains power. The processor, radio and software on the mobile computing device 102 an the entity detection device 110 device 110 use low power RF communication protocols including Bluetooth Low Energy (also known as Bluetooth 4 or Bluetooth smart). Optionally, a compass may also be included in the mobile computing device

An entity connected to the Entity Detection Device 110 and the user caries the Mobile Computing Device 102. There can also be fixed also referred to as a “hub” and/or temporary Mobile Computing Device 102 “hub”. An example Mobile Computing Device 102 acting as a temporary hub could be a mobile phone put inside a backpack in a hostel where the bags 299 has Entity Detection Device 110 embedded into the bag for example which could tell the owner remote to the hostel.

The Entity Detection Device 110 consists of a processor 112 with software 113 which can run programs, including but limited to monitoring inputs, aggregation, storage and communication of measures and receiving of status to display visually 114 or audibly with an alarm or sound generator 115 as well as communicate using lower power RF Bluetooth, and Bluetooth Low Energy (Bluetooth 4) using an antenna 116 and powered by a battery 111 that is often but not limited to being small and non-rechargeable such as a coin battery. The sensor device has an accelerometer 118 and/or gyroscope 119 sensors, input/output ports 117 for interfacing to sensing and contact switches 190 as well as output ports 191. Components of the entity detection device 110 are wired to the processor 112 by the electrical contact wire 198.

The input and output ports 117 may use a variety of protocols including I2C, 1—wire, etc. All possible types of of input sensors 190 measuring physical properties, including, but not limited to pressure, magnetism, water content and movement may be connected to 117. All possible types of output 191 may be connected to 117. With reference to the entity detection device 110 at the time of writing this description the Texas Instruments cc2540 is one example processor 112 which also includes a software stack for Bluetooth Low Energy which is a component of the overall software 113.

Optionally, a compass may also be included in the entity device. The entity device is equipped with a processor which can use different amounts of power depending on whether it is in the listening for devices, receiving, transmitting, sustaining a pairing or bonded connection, or sleeping. When the device is sleep it is used limited power and can be “woken” from the sleep state by a timer which can be used to tailor the frequency with which the device wakes up and so uses more energy based on the circumstance, risk level and so reasonable frequency or amount of time to wait between each time the processor wakes ups and listens or transmits. In the case of the Entity Detection Device 110 it is optimal to choose a monitoring mode wherein the Entity Detection Device 110 minimised transmissions and performs listening in by polling at a certain frequency between which the processor sleeps and in this configuration only transmit when an event occurs. The Entity Detection Device 110 can also be equipped with accelerometers and other input output sensor devices. These can be used to provide a signal that wakes up the processor to avoid the processor needing to wake up periodic to check these sensor devices.

Typically, for an entity using low power RF such as Bluetooth 4, to transmit takes most power, to be listening or receiving less power and to sleep till woken up by devices such as accelerometer 118, still less power including the accelerometer 118 or other such input/output devices power needs, while sleeping and awaking on a timer the least. Transmitting with Pairing or bonding typically has a bonding time of at least ten seconds and so uses more energy and is to be avoided if one of the other strategies can be utilised The Strategy is to reduce the time awake (not in sleep mode), limit receiving, polling for listening time, really reduce transmission time which uses the most power including a higher peak load.

In order to determine whether an entity detection device 110 is detectable by a Mobile Computing Device 102 as well as ascertain the distance and while minimising power a multiplicity of techniques can be employed previously described monitoring modes where the Mobile Computing Device 102 controls the polling listening frequency of the Entity Detection Device 110 and minimises the need for the Entity Detection Device 110 to transmit as well as maximise sleep and attempts to use acceleration and other Input/Outputs as a method to wake up the Entity Detection Device 110 wherever possible. “Polling listening frequency” refers to the frequency with which the Entity Detection Device 110 or also Mobile Computing Device 102 wakes up the processor and listens for transmission from another device. “Polling transmitting frequency” refers to the frequency with which the Entity Detection Device 110 or also Mobile Computing Device 102 wakes up the processor and transmits for another device to receive. In all cases of polling optionally the processor may already be awake and so not need to wake up first as described.

In all the cases the frequency that the can be determined is determined by zone, time, acceleration, or user setting of preference or the user wishing to say when turn on temporary different monitoring. Depending on the entity being monitored time has a large effect on the frequency of checking, for example during night unless it is a regular occurrence, there is little point in checking if a user is leaving before 5:00 in the morning so the Entity Detection Device 110 can be configured for the night interval for an Umbrella 131. Acceleration for example can be used to determine whether an Entity Detection Device 110 should wake up and warn the user, for example in the case where a bags 299 is moved the detection of the acceleration could be used to wake up the Entity Detection Device 110 that transmits a signal to the Mobile Computing Device 102 to indicate that it has been moved, and when the Mobile Computing Device 102 finds it is not moving or to the same extent an alert can be triggered on the Mobile Computing Device 102 and/or the Entity Detection Device 110.

One primary advantage of the prolonging the life of a battery is to increase the battery length to be such that the Entity Detection Device 110 can be designed at cheap cost or more durability or water proof without a battery replacement section in the casing. A database of weather information 136 collected from various sources which can be accessed by the user's 101 mobile computing device 102 holds current, past and predicted UV values 141 and weather values including for precipitation 142.

Entity Detection Devices 110 connected to entities such as umbrella 131 and sunscreen 133 and hat 134 whose need is determined by the UV radiation for the day 141 or weather conditions 142 for the day can in addition to the mobile computing device 102 receive this data to enable them to co-operate along with the mobile computing device 102, as discussed in the monitoring modes, in the process of reminding the user to take the items when the UV and weather conditions require. For example the polling transmission of listening frequency for an umbrella or sunscreen may be increased when the UV data 141 for the day is high.

A database of locations and associated risks 138 can hold records for different locations containing geographical coordinates, a list of transmitters detectable in an area or other indicators and an associated risk level. The risk levels may also vary according to time. The risk level may be expressed for example as one non limiting example as a percentage. One example record could be for an airport 140 where because of the high number of people, thefts and other issues as tired users 101 the risk is high at perhaps 10 percent. An other example record could be for an office 139 where the risk is low 1% during the day but high 10% if any items are left unattended. As discussed in this description, including as monitoring modes, zones and areas with different risks are important in the determining the operation of the system this information is stored in the database 138 and can be used

Other high risk locations include universities, school and gym locker rooms and hotel rooms where keys may have been duplicated. A database of entity profiles 137 can hold information of characteristics of individual entities that should be taken into consideration by the system during operation for example, how much acceleration activity is required before movement to be detected for example in the case of a bag, just knocking a bag should not cause it to alert that it is being stolen in some situations. Other identification information such as users associated with an entity as some non limiting examples. Additionally for entities how often to alert, how to alert and how much before to alert. Many other configurations settings could be contemplated depending on the entity.

Weather and UV information 136, via low power RF communication 121 can be communicated to the mobile computing device 102, and to the hat 134, 101 via low power RF communication 149, to the umbrella 131, 101 via low power RF communication 148, to the sunscreen dispenser 133, 101 via low power RF communication 146. Zone or area and associated risks information 138, via low power RF communication 121 can be communicated to the mobile computing device 102, and to the hat 134, 101 via low power RF communication 149, to the umbrella 131, 101 via low power RF communication 148, to the sunscreen dispenser 133, 101 via low power RF communication 146, to the child 132, 101 via low power RF communication 146, to the bag 135, 101 via low power RF communication 146.

Entity profile information stored in the database 137 can specify for an entity, it's ID, and characteristics such as how much movement and other tampering and actuation before an alert, as well as differences according to the location and time, as well as who to contact and what alerts to generated. In addition to profile for a bag 175, a record for an umbrella 174 and sunscreen 144 are some other examples. In the case of the sunscreen, it may also specify that if the sunscreen was detected to have been applied, then do not warn the user when leaving the house as well as allow as days of the week to be excluded from the reminder for example if the person is an office worker so that it will only be active on the weekend.

Entity profile information 137, via low power RF communication 121 can be communicated to the mobile computing device 102, and to the hat 134, 101 via low power RF communication 149, to the umbrella 131, 101 via low power RF communication 148, to the sunscreen dispenser 133, 101 via low power RF communication 146, to the child 132, 101 via low power RF communication 146, to the bag 135, 101 via low power RF communication 146.

In the situation of being at home and noticing that the user is moving 123 away the system checks to see if any entities that are desirable to take are being taken.

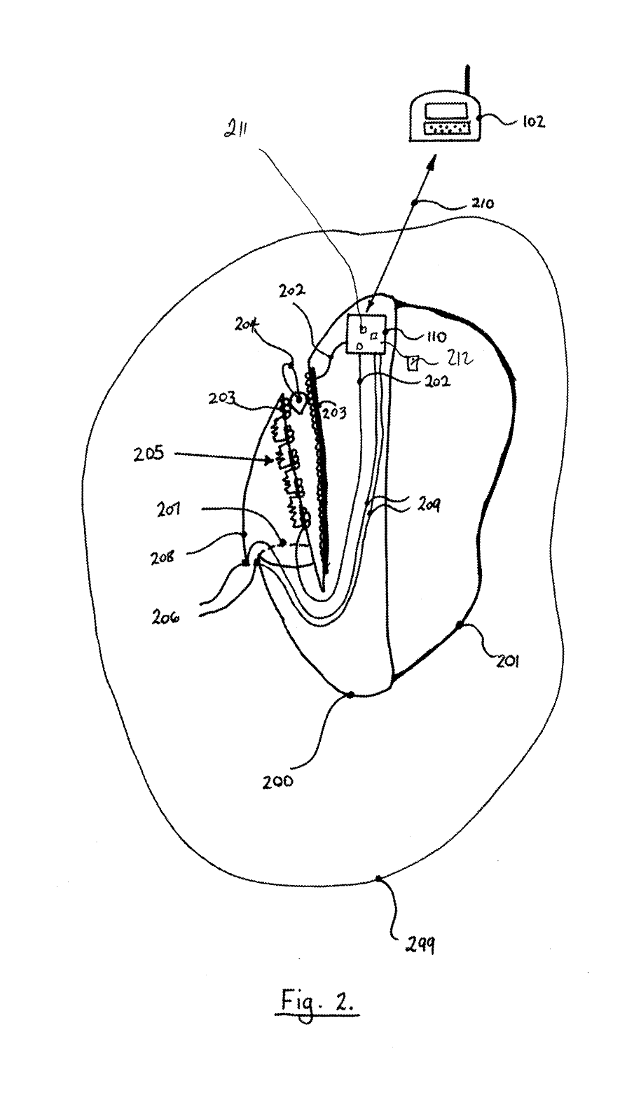

The system described allows a user 101 to be provided with various alerts when the entities such as umbrella 131, child 132, hat 134, sunscreen dispenser 133, or bag 135 (depicted in detail in FIG. 2 as 299) or any other desired object attached to entity detection device 110 move out of range or further away a mobile computing device 102. Initially devices are in listening mode configurable time or some factory setting for example every 10 minutes, every hour, or when a configuration button for the purpose of allowing configuration is activated. The mobile computing device 102 such as an iPhone sends a signal which is received after the said configuration time period or when the configuration button is pressed to set the Entity Detection Device 110 into configuration causing the device to temporarily listen and receive data from the Mobile Computing Device 102 while configuration settings set.

In the configuration mode, the mobile computing device such as a phone, then transmits preferences such as listening polling frequency times including using default values, or values for various levels of battery usage. For example, times for the device to wake from sleep mode could be set to 6:00 am the earliest someone would leave for work and need to be reminded to take. The Mobile Computing Device 102 can also monitor times when the user leaves the house or other zones using course GPS changes such as acquiring the GPS when leaving the house and/or position changes, radio triangulation for mobile towers when leaving the house and/or position changes, WiFi signals and other radio signals including Bluetooth Low Energy beacons when leaving the house are lost, and use these to adapt the times that the device is turned on to listen by uploading these configuration preferences to the device.

The Polling time between the Mobile Computing Device 102 and Entity Detection Device 110 can be selected for a given frequency synchronised according to a set time. Polling times are set according to the hazard of the area, time of day, weather.

In addition to the Entity Detection Device 110, the Mobile Computing Device 102 can also turn off or disable in a similar manner to the Entity Detection Device 110 its monitoring modes and functions to reduce power usage and improve Mobile Computing Device 102 performance when unnecessary monitoring is not required.

The Mobile Computing Device 102 monitors to determine when the user leaves the house including for example any combination of indications including also time. The system also can learn over time what these combination of indicators are as well as being trainable by the user or automatically noticing potential Patterns of accelerometer 118 and gyroscopic recordings and paths can also be used solely or in combination with other indicators. The acquisition of one or more of GPS signals, including course GPS, radio triangulation for mobile towers as the user moves out doors, the loss of home WiFi signals, or acquisition of external and other radio signals including Bluetooth Low Energy beacons and use these to adapt the times that the device is turned on to listen by uploading these configuration preferences to the device. A later indicator may also include the movement of the car if the user starts to drive away.

Optionally at the time the Entity Detection Device 110 and Mobile Computing Device 102 wake up or at some point prior to leaving 123 the Mobile Computing Device 102 establishes whether the Entity Detection Device 110 is present so that if not present there is no need to later warn the user. If the user has Entity Detection Device 110 connected to items which are only sometimes needed depending on variable circumstances, then the Mobile Computing Device 102 will check each day whether the item is required, for example if an Umbrella 131 is an entity that the user has then the Mobile Computing Device 102 will check for a rain prediction so that it will not need to later remind the user to take the Umbrella 131 if it will not rain. In a similar way if the user has hat 134 and/or sunscreen 133 and/or sun glasses, then the Mobile Computing Device 102 will check whether the UV readings will be high for the day as if UV will be low there will not later be a need to remind the user to take these items.

For example, time such as Days of the week certain items like a sports bag 299 may be important to take. This can be configured in a calendar on the Mobile Computing Device 102.

When the Mobile Computing Device 102 determines it and the user has left the house as described, and it finds always or optionally only when additional weather, time or other criteria are fulfilled, it either transmits to the Entity Detection Device 110 to respond so that it can measure the transmission strength of the signal from the Entity Detection Device 110 and/or begins listening polling for the Entity Detection Device 110 to see if it transmits and confirms it is also moving or has very recently.

If the Entity Detection Device 110 has been moved as sensed for example an accelerometer 118, then it will increase it's listening polling frequency or transmission polling frequency to tell the Mobile Computing Device 102 that it is being moved.

By these various methods, the Mobile Computing Device 102 receives a measurement of the signal strength and hence distance of the Entity Detection Device 110 in relation to the Mobile Computing Device 102 and if it is not a close distance or the user and Mobile Computing Device 102 moved but not the Entity Detection Device 110 and by these means that the entity has not or may not have been brought then an alert that the entity has been left behind is issued on the Mobile Computing Device 102 and/or the Entity Detection Device 110.

If time and conditions indicate that the item should be taken and not forgotten then an alert is generated to the Mobile Computing Device 102 and/or Entity Detection Device 110.

A range of additional rules could also include checking that if a sunscreen 133 has already been applied then the user may not need to be reminded to bring it.

In one situation the user begins in a home zone 171 (as indicated by being within range of a Bluetooth network or beacon, Bluetooth Low Energy network, signal or beacon, WiFi local network 100 or at a given position determined by GPS and radio tower positioning), when the user leaves home as indicated by loss of connection or weakening of signal from these networks, beacons or signals, or a detected increase in distance measured by Bluetooth Low Energy proximity function, as measured by the mobile computing device 102, then an alert is provided as the user (with associated 102) and object (with associated 110) move away from each other according to settings in a database 137 for each entity. In the case where sunscreen has not been applied as detected by the entity detection device 110 (having failed to receive a dispense detection), then when the user is detected to have left home 171 without applying sunscreen so is at risk of sunburn an alert is given not to leave the sunscreen behind. In the case where the sunscreen has been applied sunscreen it may still be important to ensure that the sunscreen is taken as it may need to be applied later so an alert may also be given not to leave the sunscreen behind. In the database 137 a record 175 for bag 299 may specify days of the weak a sports bag 299 or laptop bag 299 should be taken. On these calendar days according to the record for the bag 299 if the bag 299 is required the user is alerted. The configuration information for the bag 175 in the database 137 may also include information such as which users should be contacted if an alert occurs in relation to the bag 135 as well as much movement and/or opening according to different locations and times (and hence risks) is to be recorded before an alert is generated as well as after what distance the bag is to be considered to be out of safe range and an alert generated. Configuration settings for an umbrella 174 could set the locations with high risk of forgetting and so more frequent monitoring as well as safe distance or difference in movement that would trigger an alert and how the alert is displayed whether in the mobile computing device and/or the entity detection device mounted on the umbrella.

The software on the application can be trained by taking allowing it to record the events that occur has it leaves the house in terms of changes.

When user and entity leave home the emphasis on protection moves from forgetting to take from a safe environment where inconvenient rather that getting lost to one where get lost or stolen.

Database can use pre exist zones and hazard levels and/or user can also define their own with the zones and hazard levels where the software on the mobile computing device can also notice common locations and ask for a rating. Crime statistic maps providing by police may be one source where geographic locations and areas have associated crimes statistics from which given a coordinate a risk level for different levels of personal and property safety can be looked up.

Users voting on crime safety based on areas they feel safe and/or times they turn on for example a panic alarm into stand by mode or use a panic alarm can also be combined into a database.

The zone the user and Mobile Computing Device 102 Entity Detection Device 110 is in is determine from GPS, WiFi, radio position, Bluetooth as determined by the mobile computing device. The zone with corresponding hazards and coordinate and geometry is looked up database 138. The polling time is retrieved by using GPS lookup from phone to lookup to find risk.

The device can also determine an area using an low power RF signals such as Bluetooth Low Energy available. The polling time and monitoring mode including also bonding or pairing is varied according to zone and/or if the Mobile Computing Device 102 and/or Entity Detection Device 110 are moving and/or also time. For example, if moving there is a greater risk of a child 132 and parent, or bag 299 and person being quickly separated for example, if travelling on a train or in a busy station then so this increased risk triggers a more frequent communication between the devices established to ensure that separation or opening of a bag 299 is quickly identified.

The listening polling could be done with the bag 299 listening and only transmitting an alert if the signal strength and hence distance is reduced below a certain level indicating for the risk level the distance of separation is concerning or acceleration and other movement indicate concern that the object is moving away quickly. Optionally, also in listening mode the Entity Detection Device 110 may let the Mobile Computing Device 102 know the device is still present by issue occasional transmissions from the Entity Detection Device 110. This style of occasional transmission or heart beat as well as allowing the locating of the device also provide some protection against a thief attempt to shield or jam any alert signals from the Entity Detection Device 110 as the Mobile Computing Device 102 can detect the lack of a regular heart beat as an alert condition. Again the heart beat can be varied according to the desired battery usage needs and safety of the location and movement.

The frequency of connection between the Entity Detection Device 110 and Mobile Computing Device 102 may be even increased to that pairing with polling in the range of seconds which does have advantage of instant communication of distance as well as passing of acceleration movements which if zone hazard high and both items not acceleration in unison or individually indicate potentially for example, a bag 299 is being moved away from the user which may be helpful in high risk areas where a thief may take away an object while the user is busy and there are so many people around that it is difficult to notice the theft is occurring.

The parent can define a play park setting in the play park 137 with a set distance of separation between the Mobile Computing Device 102 and Entity Detection Device 110 after which an alert is generated. This is helpful even if the child 132 is still around but just out of sight of the parent which is annoying for the parent to keep on checking. The Mobile Computing Device 102 which has a larger and also rechargeable battery source transmits constantly or at assigned frequency intervals which can also be synchronised with the Entity Detection Device 110. When the distance between the Entity Detection Device 110 and Mobile Computing Device 102 pass a threshold that is still close enough that the Entity Detection Device 110 has the ability to transmit to the Mobile Computing Device 102 the Entity Detection Device 110 will alert the Mobile Computing Device 102 the child 132 is getting out of range. In this way, the Entity Detection Device 110 uses listening polling to notice the transmission from the Mobile Computing Device 102 and calculates the signal strength and estimates a distance, avoiding the need to transmit often.

As previously described a heart beat transmission depending on the risk in the area or zone could also be combined with this approach. If the heart beat is frequent enough this could replace the need for the Mobile Computing Device 102 to transmit and the Mobile Computing Device 102 would calculate the distance from the signal strength from the Entity Detection Device 110 and warn when it falls below a certain level and so a predicted distance. Additionally a pressure sensor or contact switch, or heart rate, including heart beat signature could be used to ensure that the child 132 still wearing an alert also given.

In one embodiment, all the communication between the mobile computing device 102 and entity detection devices 110 is via Bluetooth Low Energy signals or other low power RF.

The system described also allows a user 101 to receive alerts if an entity such as a bag 135 (299) is moved such as when being picked up, being moved away from the user and so mobile computing device, opened as measurable by acceleration and gyroscopic calculations particularly with reference to the hazard of the area relating to location and/or time as well when the user selects closer monitoring of the entity.

Again the zone area, movement time, will determine how often again polling transmissions signals are sent. By controlling these variables unnecessary battery can be reduced. The polling time can also be varied by user at request following at the next opportunity that the device synchronises when for example the Mobile Computing Device 102 polls the Entity Detection Device 110 a new polling frequency at user request because the user feels a zone is unsafe or by looking up the user, Mobile Computing Device 102 and Entity Detection Device 110 current position and on noticing the risk level in a database is high setting a fast polling frequency.

For example, when one a bus 155, train or plane and the user leaves luggage to go to the toilet, then in order to ensure that he is aware if anyone opens or moves his bag 299 while he is in the toilet and Entity Detection Device 110 monitors the bag 299. An alarm and/or flashing display may also be given to deter an attack in addition to the alert being sent to the user's Mobile Computing Device 102. The bag 299 may also have insignia (such as a trademark) or a display that flashes or in other ways indicates that the bag 299 is protected by this system as a deterrent to thieves. In another example, a user may have a bag 299 stowed under a bus, when the bus stops and the user is on the bus separated from the bag 299, if the bag 299 is moved significantly more, for a prolonged time or in a consistent paths that may indicate the bag 299 by accident or theft is being carried away as determined by accelerometers and gyroscopes and other sensors, and optionally the same movements are not being made by the Mobile Computing Device 102 with the user.

In order to achieve this the Mobile Computing Device 102 and Entity Detection Device 110 both monitor acceleration patterns. The user may either be aware of this risk knowing that while he cannot get off the bus and the bags 299 are being taken out he can do nothing to know if someone has his bag 299. If a difference in acceleration is noticed then the user is warned via his Mobile Computing Device 102 and he can remotely activate an alarm on the Entity Detection Device 110 or an alarm on the Entity Detection Device 110 may be activated automatically.

Or the previous travel acceleration on the bus or by some other information the system may know the that the bag 299 has been travelling on a bus that is now stopped and this analysis may be performed automatically for example when the bus is stopped for a period of time. Additional heuristics can be employed to detect if the Mobile Computing Device 102 has no accelerations at all indicating that the user is not holding the Mobile Computing Device 102 so that comparison of movements of the Mobile Computing Device 102 and Entity Detection Device 110 is not to be made.

Modern cars have mechanisms to detect if someone is sitting in a seat but the buckle is unfastened there is no such mechanism for child seats 160 in cars. In the case of a car seat 160 in a car holding a child 161 safely by a seat belt 162 the child is safe only if the connector or buckle 163 is connected. An entity detection device 110 with a contact switch 164 connected to the buckle can sense if it is connected to the belt 162.

Depending on the measurement required, input sensors 190 measuring physical properties, including, but not limited to pressure, magnetism, water content, movement may be connected to 117. All possible types of output 191 may be connected to 117.

The amount of acceleration and time as well as angles of movement as measured with an additional gyroscope 119 which constitute adequate movement and so brushing or flossing may be recorded for an individual or taken from a library of recorded acceleration sequences, the sensor pattern database 195.

The sensor programs 197 are stored as in a sensor program database 193 that can be shared between users. Each Sensor program has an associated Title, Icon and Description. The sensor programs 196 can be uploaded to an entity detection device 110 and/or mobile computing device and/or backend server to perform the processing.

In this first embodiment, a user is warned via an alert or warning on their mobile computing device 102 of the absence of an article from close proximity to a user when the user is moving and so in the process of potentially leaving the article behind. A feature of the system is that it will not alert the user if they have the article in close proximity as they transition between defined areas. This is an important usability consideration as false detections or warnings make a product annoying and ultimately unusable. Movement can be detected as the transition between geographical areas or by detection of acceleration or inertial positioning systems including sensor fusion including the combination of accelerometers, compasses and gyroscopes. In one case, movement detected as the transition between areas may be the trigger to begin the checking of a proximity determination condition that may be immediate at the point of transition or beginning of a further type of monitoring of proximity. The proximity determination condition may involve the determination of distance between a mobile computing device 102 and entity protection device, also known as an article protection device 110. It may also involve the ability of the mobile computing device to discover the advertising device 110 by Bluetooth technology or the ability to detect a difference in acceleration experienced between the two devices 110 and mobile computing device 102.

Articles or Items including health protection products like sunscreen, hats and also valuable items which a user may wish to be reminded if in the process of being left behind are protected from this by the placement of an entity protection device 110 being a bluetooth low energy tag placed on, or in other ways connected to the article or item. The entity detection device is also referred to as the article protection device 110. The device 110 may turn on at a set interval, or for a period of time to transmit or receive when moved as detected by the attached accelerometer 118 in one non limiting example. The setting of the times and conditions including when the device 110 is moved as detected by an accelerometer 118 attached to the device 110 is configured by the pairing of the device 110 with the mobile computing device 102 and configuring of periods, movements under which the device 110 turns on through the display and keyboard of the Mobile computing device. The entity detection device may also be termed an article protection device.

Examples of the kinds of items or articles which may be protected from being left behind by attachment of a device 110 include medication such as epi Pens™, asthma inhalers, Insulin, pill containers or packets and syringes, environmental protections such sunscreen, clothing, hats and umbrellas, valuable items such as wallets, keys and another item of value taken away from safe areas such as a house, and items that are required at particular times such as gym clothes or mouth guards for sport or any item that is needed to be remembered from time to time.

The mobile computing device 102 may also be a smart watch with global positioning system and, or internet connection or fitness bands or similar without global positioning system or internet connection where acceleration or inertial position systems patterns are used to detect location movement and described proximity checks to ensure that the associate article with connected device 110 are not left behind.

Some scenarios in which the described system is helpful include, Firstly, a health protective article such as asthma inhaler typically needs to be taken and not forgotten when leaving the house zone. In addition to health protective products it may also be important to remember to take an item like wallet or keys to the office when leaving the home. The system works by having the mobile computing device carried with the user detect by means of location detection from, for example a global positioning system combined with a database of geographical areas or zones (including a defined home zone) when the zone such as home zone has been left and the mobile computing device attempt to Bluetooth pair with the device 110 connected to the article. If this pairing is unsuccessful and also typically checking the distance between the mobile computing device and device 110, the article is considered to be not being carried with the user and an alert generated on the Mobile computing device.

Secondly, in the case of a valuable article, the risk is not in forgetting the valuable item when leaving the house initially but in forgetting to carry or take the article with the user when in an environment where it could be taken by a second party if forgotten and left behind. The system works by having the mobile computing device with the user detect by means of location detection from for example a global positioning system combined with a database of zones (including a defined home zone) when the home zone has been left and attempt to Bluetooth pair with the device 110 connected to the article. If this pairing is lost before the Mobile computing device re-enters the home zone, the article is considered to be not being carried with the user and an alert generated on the mobile computing device.

Thirdly, in a further scenario it may be helpful when returning home to ensure that the user has brought home things such as keys and wallet at the time of arrival so that if they have been lost the user can quickly work out where they were and go and retrieve them rather than discover later that they did not bring them home. When the user arrives home, as the mobile computing device detects entry to home zone, then the Mobile computing device pairs with the entity detection device 110 attached to the article, for example keys or wallet. If the Bluetooth pairing (or pairing) is successful and also optionally the distance close between the device 102 and 110, then the user can be informed that the articles have been brought home. A user may use this a alert to place them in a set place. If the pairing is not successful, then the user is informed that the device has not been brought home.

Fourthly, when leaving a house or home zone or work office zone it may be important be informed if any appliances such as a gas stove have been left on or if a window has been left open. The system works by having the mobile computing device with the user detect by means of location detection from for example a global positioning system combined with a database of zones (including a defined home or work zone) when the zone has been left, an attempt is made to Bluetooth pair with the device 110 connected to the article such as a stove or door. If this pairing is unsuccessful, the article is considered to be not being carried with the user and an alert generated on the mobile computing device to say that it is not possible to know the state of the article for example whether the door is closed or stove is off. If however, a bluetooth pairing connection can be made, the state of a sensor such as a flame or gas sensor determines if the gas is off or on, or in the case of the door via means of a magnet connected on the door and reed switch or hall effect sensor on the door frame determine if the door is open or closed.

Fifthly, in a fast moving environment like a bus, where the accuracy of a distance determination between a mobile computing device and entity device connected to an article which is not to be lost is not good enough to trigger an alert before the person is out of range, for example already left the bus, then the following additional monitoring can be applied. In one situation a user has a mobile computing device with them, perhaps in their back pocket. They are carrying an article, which is a bag to which an entity detection device 110 is attached. The user is at a bus stop waiting for a bus. The user places the bag on the floor of the bus stop while waiting. The risk is that the user will forget to take the bag when the bus comes and may only realise that he has forgotten the bag after the bus starts to move off. A means is required to immediately warn the user as soon as the bag is beginning to be left behind as the user moves to enter the bus. The system works by having the Mobile computing device with the user detect by means of location detection from for example a global positioning system combined with a database of zones (including a defined home zone) when the bus stop zone has been entered and attempt to Bluetooth pair with the device 110 connected to the article. Upon successful pairing, the acceleration of the Mobile computing device is monitored by an accelerometer or IPS component in the Mobile computing device. If the acceleration or Inertial positioning System

(IPS) sensor data is similar to that recorded on the Mobile computing device then the article is considered to be been taken with the user entering the bus and either no alert or a confirmation message is displayed on the Mobile computing device. This system also overcomes the problem of a lack of granuality of detection of movement by the global positioning system meaning that location movement detection is too slow compared to the changes involved while using transport to initiate the Bluetooth pairing and checking.

Alternatively, when the measurement from these sensor is estimated to be caused by standing up or walking action of the user, then the mobile computing device via the paired connection requests the acceleration or IPS sensor data via a bluetooth low energy connection from the device 110 connected to the article. If the acceleration or IPS sensor data is similar to that recorded on the mobile computing device then the article is considered to be been taken with the user entering the bus and either no alert or a confirmation message is displayed on the Mobile computing device. If, however the acceleration or IPS data is different and particularly if the entity detection device 110 acceleration or IPS sensor data registers no movement then an alert is given on the Mobile computing device to indicate that the bag may being left behind.

In one example, involving an umbrella, when the user leaves the house, is at another location and returns home or is on a bus, there are opportunities for the umbrella to be left behind that this system can assist with. As described in the first scenario above when leaving the house, when a device 110 is attached to an umbrella the problem of remembering to take an umbrella when leaving the house can be solved. As described in the third scenario when leaving another location such as work location the system can help the user remember to bring home the umbrella and as described in the fifth scenario, when travelling on public transport it is easy loose umbrella and this scenario helps to solve that problem.

An important feature of the system is that it can simplify and reduce the configuration burden on the user. For operation of the system geographical areas need to be defined and articles associated with areas and transitions. Mobile computing devices are configured with location detection systems including global positioning systems (GPS), radio beacon triangulation systems, Wi-Fi and Bluetooth beacons. These systems may function in the background to constantly monitor the position of the user and identify geographical areas and routes occupied or traveled by the user. Geographic areas of significance to the user's life pattern may be deduced from this data and presented to the user for classification.

The classification of geographical data collected by monitoring locations as described above may be performed by identifying places or routes commonly frequently or traveled. Utilising the user interface of the mobile computing device, the user may additionally be asked either at the time of being situated at the location to classification it. Alternatively, the user may be presented at a time subsequently to this a map showing the location identified. The classification required from the user involves the determination of one or more of the following factors in relations to an area or route.

Firstly, the area type which consist of special locations such as home, work as well as more generic safe or risky areas for leaving items. The area may be specified on a map as, in one non limited example where the user may specify by selection of a position on the map with for example a finger selection the centre of a region from where the radius can be specified by means of graphical or number selection through a UI for example via pinching and widening action with their fingers. A polygon may as an alternative to a circle be chosen to represent a geographical area or zone. After selection of an area or region, a series of menus may then prompt for specific information to be entered beginning with a classification of the zone for example as home, Safe or Risk. The geometric shape selected may also allow squares, rectangles, and polygons enclosing an area corresponding to a physical area in the world. The geometric shape is selected on a map representing a physical area in the world by means of a graphical interface on mobile computing device.

For each zone, a type for the area which corresponds to, for example, safe areas where we want to remember to take a needed article such as Work, Home or Risk. Home zones includes places where leaving behind health protection articles including hat or sunscreen such as the route toward say beach or other outdoor locations or school or a mouth guard is in issue. Risk zone where theft is a risk such as mall as well as areas of rapid movement such as bus stop bus and also frequently visited locations such as a coffee spot.

Secondly, after selection of zone and type, next the transition from the zone needs to be defined that will trigger a proximity determination check which may be specified as leaving or entering an area include for either an immediate check of proximity to the article to which device 110 is attached, or for the initiation of additional subsequent proximity checking such as previously described checking for differences between the devices in acceleration.

Thirdly, the proximity check to perform given the trigger. The proximity check may be either a pairing between the Mobile computing device and Bluetooth low energy device 110 and distance measurement using the Bluetooth RSSI service, or the checking by Mobile computing device for a transmitted signal or ID at intervals from device 110, or the pairing between Mobile computing device and device 110 and comparison of the same acceleration or movement measured by the acceleration or IPS sensors on both devices, reporting if they differ particularly the detection of the Mobile computing device moving but the sensor connected to the device 110 attached to the article not registering movement. Lastly the proximity checking may be the pairing of the two devices and detection of starting or standing up acceleration or IPS sensor measurement on the Mobile computing device triggering a check for similar movement or any movement as measured by the accelerometer or IPS sensor on the device 110. A final alternative for proximity checking may involve the mobile computing device simply being in range to receive a signal from the device 110.

Fourthly, a time condition may also be selected such so that the checking above and alert is only done if it is for example a day of the week or time of year which is relevant, for example Gym shoes on Wednesday or take a present on special occasion defined in a calendar that an application on the Mobile computing device for this system can access.

Fifthly, an extra condition such as a weather condition such as UV or rain prediction may also be needed before the previous checks are performed.

Sixthly, the articles may typically be a health related article such as epi Pens™, asthma, sunscreen, umbrella. It may also be a valuable such as a wallet. It may also be equipment required from time to time.

Additionally, the report in addition to proximity may also depend on the checking if a value stove flame or door open where the device 110 is monitoring these.

Additionally, the presence of a person such as a child as indicated by the transmission of a bluetooth low energy ID attached by a device 110 attached by wrist strap to the child may need to be received by the Mobile computing device before the other checks are performed or report given as the check may only be relevant if the child is also present.

Finally, any reports generated may also be configured to be only displayed on the Mobile computing device or also sent to a remote third party. For example, in the case of elder person or child the carer may want peace of mind the know the activity was completed

In addition to, or incorporated into this classification process, the mobile computing device may access remote databases of information collected from various sources or collected from third parties and present to users information about the locations and routes that it observes the user using to help classify an area for example as park area that may relevant to an articles such as sunscreen or hat, a bus route that is relevant to setting a high rate of monitoring, an offices area or an area where there is a high risk of theft if an article or item is left behind such as a shopping mall or railway station where crime from theft is higher. Many digital map products offer APIs allowing a lookup of an area to see the feature types like a park as well as defining the zone. Other information such as Crime rate, transport routes, beaches parks, work places may be used dependent on the article involved to determine risk of the zones.

The mobile computing device may be made aware of articles with entity detection devices consisting of Bluetooth low energy tags attached to the article by having them switch on and pair with the Mobile computing device. The user may be asked to classify the type of article attached to the entity detection 110.

The articles or items described above are all “location sensitive articles” because their importance or security is sensitive, dependent or related to different geographic areas or zone described above. For example, sunscreen is location sensitive to the transition of home to not at home. A purse is location sensitive to being left unattended in a risky area like public places like a mall or public transport where the article can be lost quickly as a person moves rapidly over a short distance off the vehicle. An article protection device (entity protection device 110) is attached to location sensitive articles.

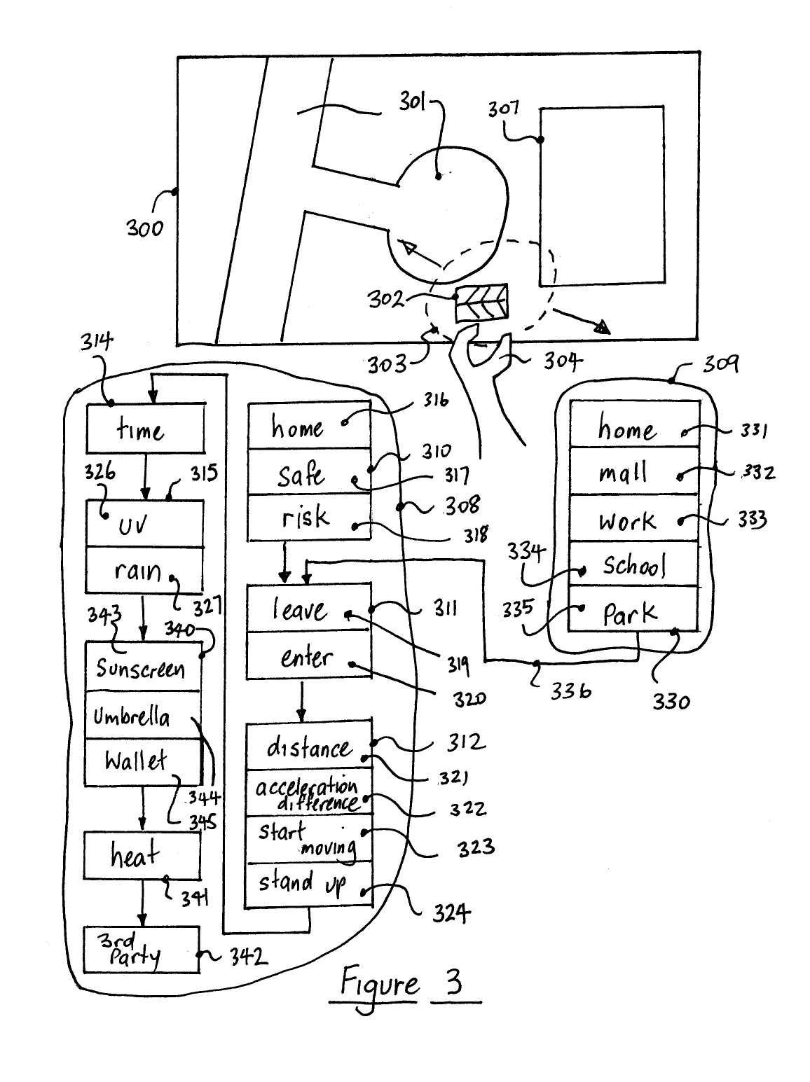

Referring to FIG. 3, a user interface is shown by which a user can configure geographic areas and the operation of the system. A map 300 is displayed with an area in focus such as a house 302. The event which initiates the display may be the user's decision to define a house zone 303 on the mobile computing device 102 via location monitoring software running in the background correlating the arrival and remaining of a user at this location for, for example, six hours each evening to morning.

The zone or area “home” is a geographical area where the user of the mobile computing resides as defined as the place that they return home each day or alternatively remain for a period greater 4 or 6 hours at night as one example. The “home” geographical area is where the user resides as detected above.

The zone “safe” is a geographical area where leaving a valuable item whether of monetary value or value in turns of inconvenience if lost will not result in someone taking it in all likelihood.

The zone “risk” is a geographical area where leaving a valuable item whether of monetary value or value in turns of inconvenience if lost will result in someone taking it in all likelihood or with a fair to high probability.

The zone “unknown” is a geographical area where leaving a valuable item in this area it is not known if it could be stolen if left there. But not considered a high risk.

Zones can also be defined negating another area for example “NOT Home” in 513 is any area that is not the home area which could be considered to be a “risk” zone.

In this example, the user wishes to define a home zone or area and associate it to a medical device such as an epi Pen™ or asthma inhaler so that when a person leaves the home area or zone 303 as detected by the location detector of the mobile computing device 102 a proximity check by the attempted pairing of the mobile computing device 102 and the entity detection device 110 attached to the epi Pen™ or asthma article can be performed to check that the entity device and so article is with the person for example within range of 1 metre. Alternatively, a check can be performed to ensure that the device 110 attached to the article is transmitting an ID and this considered close enough.

The user first defines zone or areas during a configuration phase or in response to noticing that the location is in all probability a home location. The user selects the house icon 302 on the map which it has been either automatically guided as described or has been located by the user searching for it on the map. Next, if desired to adjust the zone (if auto size not enough based on geographical database information about the selected location) the user adjusts the area 303 which is the boundary after which crossing the user will be considered to have left the home zone. The boundary of this area 303 is adjusted by the user to ensure that it allows the right distance to not detecting leaving the home area until this has really occurred. The adjustment is made by pinching or opening the user's fingers 304. If a geographical object is selected on a map from a mapping service or database, then the geographical area that it is consumes may become the boundary area the transition from which or into which triggers a change from one geographical zone to another.

After configuration of the home zone 303, in a manual configuration 308 a series of additional menus are displayed to complete the other aspects of the configuration.

These menus appear on the mobile computing device overlayed on the map display as shown by the are 307 on the display 300.

In the next menu to be displayed 310 manual input is required to specify one of three options home 316, and safe 317 or risk zone 318 types.

These are three generic zone which map to a range of different geographical zones defined in a geographical database. For example a risk zone 318 may include shopping mall 332 or school 334 or park 335 areas for valuable articles such as a wallet. A health risk 318 zone for a sunscreen could be entering a park area 335. Another type of zone or area which is not described in the menu options in FIG. 3 is an undefined zone which could for example be any area not defined as another zone. The transition from a first home geographical zone to a second undefined zone, being perhaps any area not in the home zone, could be a trigger for leaving a home zone and subsequent check to see if a health article like inhaler is with the user. The transition from a first unknown zone to a second risk zone could be used to begin pairing the devices 110 and 102 and begin checking for a difference in acceleration.

As alternative to manual setup in automatic match of assigned areas be presented with a menu 330 where more detailed information labelled the location can be assigned. The assignment to an areas is made to geographic information from third party databases or information previously entered by the user or fellow users. Once an area is identified pre configured or previously assigned information as specified through the menu entry which matches typical similar areas or zones may be assigned to this new zone automatically.

After selection from menu 310 or 330, and in this case home, the next menu 311 specifies on which transition relative to the zone the proximity monitoring is to be done either when leave or entering a zone. After this select of one of these, the next menu 312 specifies the proximity check to perform.

For example if a first zone is a home zone, where the user typically resides as determined by checking the location where a person consistently comes home, then defining a first geographical zone as home and the second as any other area that is not the home zone, then defining the menu options “home” 316 and then “leave” 319 will define the areas described above to detect the transition of between the home zone and any other zone to trigger a proximity determination. Articles which are health related and not to be forgotten when leaving home could be defined to be related and checked for in this situation. An alternate menu system could prompt the user to assign a “first area” and “second area”. In the case above “first area” would be selected as home and “second area” as the area exclusive of home, for example “NOT home”.

For example if a first zone is any undefined area or also including home and any safe zones and the second zone or area is a risk zone then articles of valuable can be checked on the transition from safe or unknown first zone to second risk zone. This could be specified as first zone “safe” 310 and second geographical zone “risk” 318 and the menu 310 could be shown twice to ask the user the first and second geographical zones to transition between or alternatively the menu 310 or 309 could be shown once as depicted in FIG. 3 and the same configuration achieved by either specifying “risk” 318 and “enter” 320 or “home” 316 OR “Safe” 317 and “leave” 311. Regardless of the method of specifying the configuration, the system will need to categorises a first and second area between which a transition occurs as specified by the user or by the categorisation of a database of geographical information such as a catalogue of area corresponding to public places which are automatically categorised as “risk” because a valuable left behind in such an environment will be stolen in all likelihood.

A database could hold mappings of mall, park, school equals areas with risk of losing valuables if lost as one example.

There are three options for proximity detection, Firstly, “distance” 321 between the user with Mobile computing device and article with device 110 attached can be determined by performing bluetooth paring and RSSI request.

Secondly, the beginning of proximity separation can be determined by measured by the acceleration or IPS sensors on both devices, reporting if they differ 322 particularly the detection of the Mobile computing device moving but the sensor connected to the device 110 attached to the article not registering movement.

Lastly the proximity checking may be the pairing of the two devices and detection of starting 323 or standing up 324 acceleration or IPS sensor measurement on the Mobile computing device triggering a check for similar movement or any movement as measured by the acceleration or IPS sensor on the device 110.

As one example if the user with Mobile computing device is at a restaurant for a period of time, even a small pause, say 30 minutes, 1 minutes or 1 hour then even without interaction with the user this location by global positioning system, radio triangulation or Bluetooth beacon, also because it is outside the home, can be treated as a new “safe” zone which when left, a proximity check should be performed using the same method as leaving home or the fourth methods described above. In this way zones may be automatically assigned, even in a temporary fashion.

After the selection of one of these options, the sixth menu 314 allows selection of additional time constraints such as the time of day, week or as per calendar.

Next a menu 315 allows selection of other miscellaneous conditions based on weather such as high UV 326 or rain 327. This is followed by an option 343, 344 or 345 to associate these conditions with an article from the article menu 340.

Another menu also selection of the kind of sensor type which may be check at leaving of an area such as a heat sensor as shown as the option in 341.

A further menus 342 allowing filtering for the report to only occur when a person is identified as present via a Bluetooth low energy device transmitted ID or GUID and lastly any third party users who should receive an alert via the internet to their SMS or email can be configured with some form of address.

In an alternative first step of the configuration 309, the initial auto configured menu 330 may be displayed if the location was auto recognised for example as “home” 331 and prompted to the user accept preconfigured settings. A database holds the preconfigured associations and settings between articles such as epi Pen™, the trigger being when the user leaves home to check proximity.

Optionally the menus described above may also include an additional menu where the a bluetooth identity tag may be configured to indicate the person who must also be present as an additional condition before the alert is given. This would typically be used to identify a child who has the allergy requiring the epi Pen™ and only if they are also present with the user of the mobile computing device, the parent, would the alert be given. The bluetooth low energy tag attached by a wrist band to the child is a variation of entity device 110 with an accelerometer, timer and wrist band has an identification ID or GUID that is transmitted when the tag being moved as sensed by an accelerometer. Use cases 1 and 2 and show examples where identity tag child_1 and child_2 are defined.

The classifications in 330 are a non limited list of example locations types each of these location types may have a stored with it a set of characteristics concerning the configurations of checking as detailed in the menus of the manual configuration 308. They can be automatically assigned at the choice of location type 330 or manually defined. At the step 330, additionally the user can create a new location type and as per the manual process 308, assign characteristics as per the menus described that are then saved in a remote database or local database on the Mobile computing device for re use.

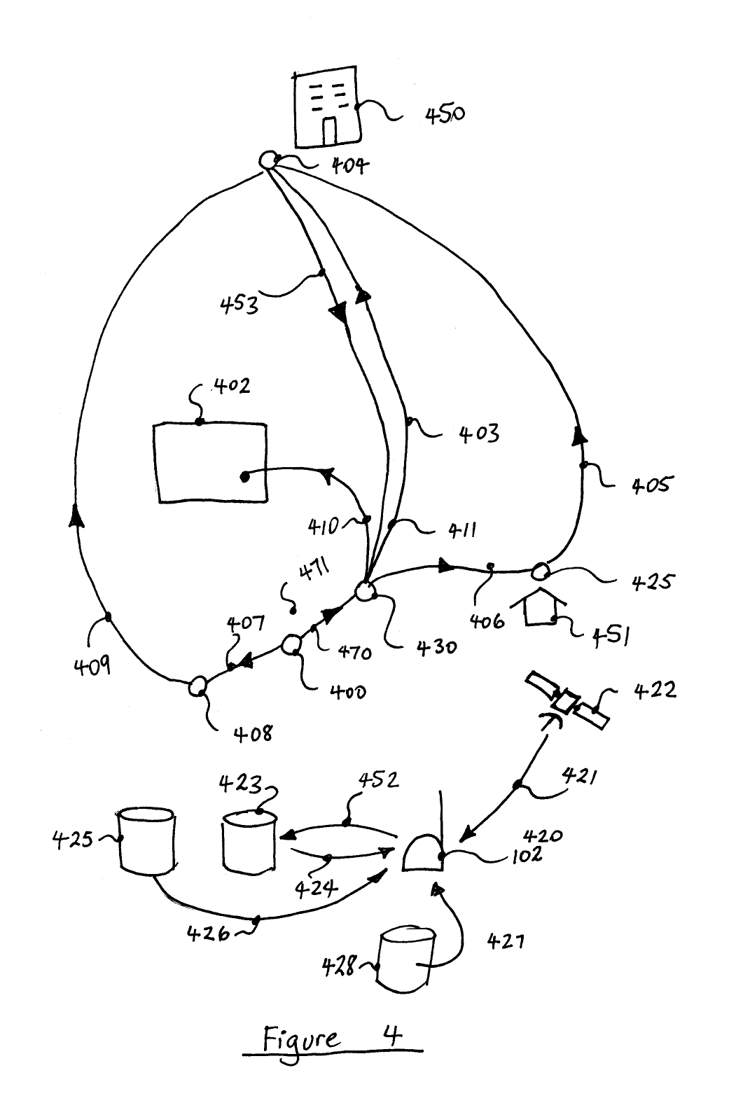

Referring to FIG. 4, the system may operate as follows. A user has with them a Mobile computing device 420 which receives location information 421 from one more location detection devices 422 including for example a global positioning system, radio triangulation or Bluetooth beacon. The Mobile computing device 420 also has access to a geographical information 423 such as the location of parks, shops, homes, work offices, natural formations such as beaches as well as transport stop locations and transport routes which can be communicated 424 by various interfaces from mapping and service providers or configured by the user. The Mobile computing device 420 additionally has access to a database of acceleration and IPS information 425 which can be used to detect activities such as movements characteristic of movement in various forms of transport such as buses, cars, trains and can be used 426 by the Mobile computing device 420 to detect when Mobile computing device and so user is in a geographical zone or area related to transport for example on a road or train line by means of correlating this information 423.

In relationship to the database of geographical information 423, as the system is used and locations which the user visits as detected by location information 421 are discovered and associated with information from the database 423 or provided by input from the user this information can be stored 452 in the database 423 which can then be also shared with other users. This allows other users can benefit from shared conditional separation checking settings configured by a user.

The user with Mobile computing device 420 on her person undertakes six different journey, trips or work flows. For each of these the user has different articles which are desired to be remembered depending on the workload.

The user has the following articles which it is desired to remember to carry depending on the journey. These are keys 403 for office when travelling to the work office location 404, hat and sunscreen 410 when travelling to the park location 402, asthma inhaler 406 when dropping the child to school 425. She also does not want to loose her purse 407 when walking to alighting the bus at the bus stop 408 or travelling on the bus route 409.

The locations of the school 406, work office 404, park 402, bus stop 408, home 400 and bus route 409 are configured automatically by reference to a database 423 and the look up of pre-configured setting as configured in FIG. 3 or configuration as defined in FIG. 3 either manually before hand.

Referring to FIG. 4, the user has three journey paths which have a common section 460 that diverge at the location 430 after leaving the home location 400.

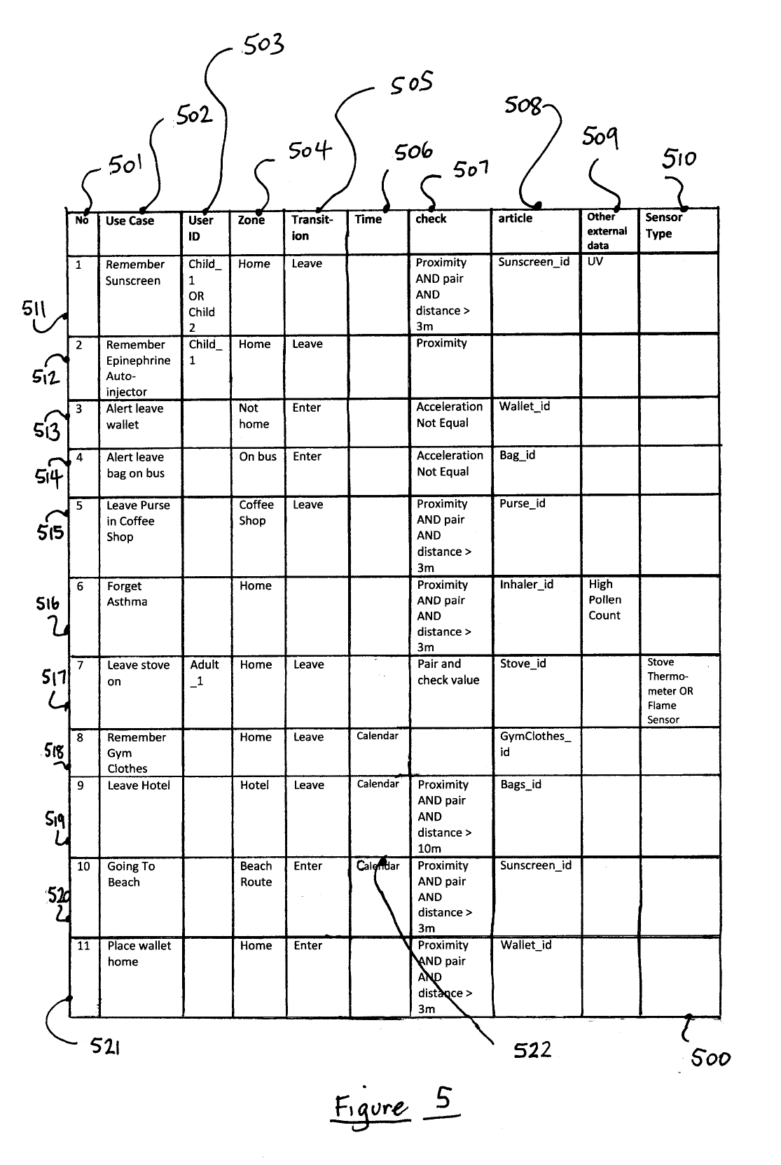

The following journeys and functionality is provided by the system. Firstly, as the user leaves or transitions 470 from the home area 400 to the area not in the home area or the area exclusive to the home area 417 heading to the park 402 she requires that the sunscreen and hats for child be taken. The system cannot determine until the point 430 is reached and crossed and continues travelling 410 to the park 402 that the user is heading to the park and not the work office 404 directly or via the school. Bluetooth low energy tags, entity detection devices, 110 are attached to the sunscreen and hats that the user wishes to take. As the user travels 401 to the park 402 past the point 430, the Mobile computing device 420 with a database of configured information 428 similar to FIG. 5, checks the proximity of the hat and sunscreen by pairing and checking the distance as configured in the database. If the devices 102 and 110 cannot pair or the distance measured by Bluetooth low energy proximity/RSSI service is greater than 10 metres then an alert is given.

Secondly, as the user heads 406 from home 400 to work office 404 via a school zone 425 the system is configured to remind the user holding the Mobile computing device to take an asthma inhaler/puffer with them as they take a child to school. Once the the common location 430 is passed after leaving the home and towards 406 as indicated by location data 421 matching route to work past school, then Mobile computing device checks if the asthma inhaler/puffer article attached to the device 110 can be paired with and so with the parent and child can be warned as they are definitely heading to school and the puffer has been forgotten. The user then continues to the office 405.

Thirdly, as the user heads to work passing the point 430 where the user could be heading somewhere else and moving toward 403 the office 404, as the key is required for work, then Mobile computing device checks if the key article with device 110 attached can be paired with and close. An alert is generated if the user has forgotten the key.

Fourthly, as the user from work zone leaves 453 the office he needs to ensure as he leaves that the door is locked. The Mobile computing device checks is door closed state sensor article with device 110 attached can be paired with and the door via a reed switched attached to the device 110 measures if a door is closed as it pushes a magnet on the door next to the reed switch. If the switch is not closed to indicate the door is open as the user is leaving an alert is generated.

Fifthly, if the user travels by bus to work first by foot 407 to the bus stop 408 and then on the bus 409 as detected by comparison of location to a database of locations and routes and monitoring of comparison of acceleration for swift alerting if there is a difference between the devices 110 and 102 indicating the leaving behind of an article is enabled.

The configuration of the articles and their interaction with the Mobile computing device 420 under the different reported location information 421 is stored in a database 428 which is either externally communicated by internet to the Mobile computing device 420 or internally stored in the Mobile computing device 420. FIG. 5 shows some of the information typically stored in the Mobile computing device.

False positives can be introduced by alerting that they have left behind an article too early when it may not be clear which route or path and hence which article is required when the user is still on a common section 460 of the path. The system can remove this kind of false positive alerting by delaying alerting until after the the user is only on a route applicable to one article only.

Additionally, false positives when multiple routes need to be distinguished or the determination of routes in general can be performed by the user's mobile computing device referencing the user's database of emails or calendar stored on the mobile computing device or email remote server and matching it with the current time in order to determine to which location a user is travelling and so which article is required. In one example, a series of geographical points captured over time by the user's mobile computing device may be presented to the user as a route or path to a location such as a beach where a user will require sunscreen. The user will confirm sunscreen should be taken when the user enters this route and these details may be stored in the database record 520. On another occasion when the user is travelling on this route the conditional check of proximity of the article to the user may be performed when the route is identified as the one and only route as described above. Alternatively if the user has an entry in their calendar 521 or email for a date and, or time the will go to a location such as the beach. The later movement along the route at this time or any movement for example as detected by the mobile computing device's global positioning system with the speed of transport at this time, or by the mobile computing device's accelerometer may be used to indicate the intent to travel to a location such as the beach zone defined in 520 or any generic beach zone and an alert given to the user as the travel begins to take the required article such as the sunscreen.

The office building 450 is located at the position 404. The school 451 is located at position 425.

Referring to FIG. 5, configuration settings for various scenarios can be stored in a local database on the mobile computing device 102 or a remote server where configurations may be shared with other users with only user ID of the child “child_id” or a geographical area differing between users and requiring specific configuration.

Typically the database 500 will contain the following fields, an entry number 501 for each configuration entry. A description 502 of the use case so that it can be selected by a user. A User ID 503 which usually consists of one or more child_Id corresponding to entity devices 110 with an associated ID that is broadcast for example for a certain amount of time with the device 110 is moved. If a parent has more than one child then one or more child_id may be placed in this field. An adult id could be used where for example a disabled carer has a few clients and for example a specific one has an article. A logic OR operator can be used if more than id. The zone(s) for which configuration is to be defined 504. More than one zone can be combined with AND and OR Boolean operators. The transition entry 505 refers to the trigger for proximity checking which may be to leave the zone(s) in the zone entry or enter. Again Boolean operators AND, OR and NOT combined with zone entry names may be used to specify the transition which triggers proximity checking. A time entry field 506 which may be days of the week, time of day or time range or based on a calendar entry accessible to the Mobile computing device or combination of these. The check entry 507 may be one of follow checks to perform after a transition has detected. The check is performed between the Mobile computing device and entity detection device attached to an article, the proximity check may including firstly, performing a proximity check by pairing the Mobile computing device 102 and entity detection device 110 and determining the distance using RSSI. Secondly by the Mobile computing device being able to receive a broadcast signal transmitted by the entity detection detection device 110. Thirdly, the proximity check being performed by firstly the Mobile computing device and entity pairing and then both the Mobile computing device and entity detection device measuring acceleration so that is the Mobile computing device has acceleration and not on entity, of different accelerations, then this is reported. This is useful when by the time a distance over a certain range may be detected the user may have left or joined transport. Fourthly the proximity check is performed after there has been no acceleration on the Mobile computing device of significant movement followed by movement indicating purposeful movement such as beginning to move away from being at a location or standing up after which pairing or periodic checking for a period of time is done. Fifthly the proximity check is performed by pairing distance after the acceleration or IPS indicating standing up motion by a person.

The article entry 508 specifies which article ID is broadcast transmitted or advertised by the article protection device 110 connected to corresponding articles for Mobile computing device to interact with.

The “other” condition field 509 specifies other conditions such as UV data which the Mobile computing device should check by access to relevant data sources such UV levels.

The sensor value type field 510 specifies if a sensor value is to be checked then what the type of sensor is. In one example, when leaving a house where it is desired to check that the stove has been turned off a sensor such as flame detector or Infrared heat sensor could used to measure if the stove gas flame or hot plate is on. On detection of the movement of Mobile computing device outside of the “Home” zone, the Mobile computing device and entity detection device 110 pair and the the device 110 using one or more of a variety of sensors, measures the physical environment and transfers via the paired Bluetooth connection the sensor value to the Mobile computing device. The Mobile computing device then determines if the sensor value is appropriate for the situation where the user is for example leaving the house. As one example, if a heat or flame detector sensor is connected to the entity detection device 110 (also referred to as the article protection device) and is mounted near a stove and detects heat or flame then the Mobile computing device upon reception of a detection value for the entity detection device will alert the user when it has been detected that the user is leaving the home zone. An example of the configuration of these details in the database, FIG. 5, shows also that an alternative time condition such as for example the time when a person leaves the house Monday to Friday at 8.30 am in the morning could be used instead of, or as well as, the detection of leaving the zone. If upon detection of the leaving of the home zone, an attempt at pairing fails, then this may also be alerted to the user so that they know that there is no confirmation that pairing occurred and so reading of the sensor value. The type of sensors that may be employed include temperature, flame detectors, infra red detectors, magnetometers and reed switches and contact switches to ensure doors are closed where a magnet is placed on the door surface and the sensor on the door frame which mates next to this surface when it is closed, as well as light sensors, water flow and electricity flow sensors which measure electric current. As one example the light sensors, water flow and electricity flow sensors which measure electric current could be employed to ensure that utilities have been turned off when a person leaves the home zone.

In an additional option not shown, the third party report field specifies the email address, mobile or other id of a person to report if check failed or succeeded.

There are five typical zones or areas below and corresponding articles relevant to them, Firstly, in the transition of home to unknown or risk is relevant to leaving behind needed items for the day such as asthma inhaler, medication or keys.

Secondly, the transition from unknown, safe or home to a risk zone concerns valuable items which if left would be taken by another including wallets, purses, bags or luggage.

Thirdly, the transition to a home area concerns keys or wallets which the user should be alerted have not come home with the user.

The geographical positions acquired from GPS, radio or other means is also described as “location movement data”. Location movement data is wirelessly received geographical data from Wi-Fi, global positioning system, radio triangulation, mobile radio cellular positioning, Long-Term Evolution based positioning and bluetooth beacons.

Again referring to FIG. 5, According to configuration entry no 1, 511, “remember sunscreen” when the home zone is left and the additional condition of UV is detected then a proximity check is made by Bluetooth pairing and monitored for some time to check the article is under 5 metres away from the Mobile computing device as measured by RSSI distance measurement. This could also be configured without the child 1 and child 2 ID. The child ID is explained below.

According to configuration entry no 2, 512, “remember ephinephrine auto injector”, when the mobile computing device 102 can receive a bluetooth low energy beacon signal with identification corresponding to child_1 from an entity detection device 110 on the wrist of otherwise attached to the child and activated typically on movement, and the user who would typically be the parent of the child has the mobile computing device 102 with them leaves the home zone, then the Mobile computing device attempts to detect and pair with device 110 attached to the epi Pen™ article. If the Mobile computing device cannot pair then an alert is generated that the epi Pen™ has been forgotten. As well as pairing it is not specified in this example by a proximity distance could also be checked.

According to configuration entry no 3 513, “alert leave wallet” when the user with Mobile computing device enters the zone defined as any area not in the defined home zone and then according to field 507 subsequently whenever the Mobile computing device senses acceleration or IPS movement corresponding to start of walking or standing up from a period of time perhaps 1 to 5 minutes following this the Mobile computing device will pair with the device 110 attached to a wallet id which transmits or broadcast this id. If the Mobile computing device does not remain paired and alert is generated. After successful pairing if the accelerations differ between the devices then an alert is generated as specified in the check field, “Acceleration Not Equal”. The system determines that an area is “not in the defined home zone” by retrieving location data from global positioning system, radio location or otherwise and checking that it does not fall with the geographic area defined by the system for the home zone. Where the home zone may be determined by the user selecting or confirming a position as the home centre and then specifying a circle or other geometric shape around this point as the home or by selecting a feature such as a building from a map where the map database holds itself the geometric bounds of the object by nature of pre-recorded data stored or deduce from the map.

According to configuration entry no 4 514, “alert leave bag on bus” when the user with Mobile computing device enters the zone defined as bus stop or bus routes (a risk zone) and then according to field 507 subsequently the Mobile computing device senses acceleration or Internal positioning system (IPS) measurements corresponding to start of walking or standing up from a period of time perhaps 1 to 5 minutes following this, the Mobile computing device will pair with the device 110 attached to a bag_id which transmits or broadcast this id. If the Mobile computing device does not remain paired or accelerations from a sensor on the article measured by an accelerometer on the article and transferred by Bluetooth low energy to the mobile computing device do not match those measured on the mobile computing device an alert is generated. Acceleration typical to the bus movement are filtered out. Alternatively when the user enters these zones then the acceleration monitoring is performed until the zone is left and the any difference in acceleration is considered to be a detection of the leaving behind of the article.

According to configuration entry no 5 515, “leave purse in coffee shop” when the user leaves the coffee shop safe zone then a proximity pair check is made and watched for some time and if the Bluetooth low energy RSSI distance/proximity service detects a distance more than 3 metres RSSI and alert will be generated

According to configuration entry no 6, 516, “forget asthma”, when the user who has asthma has the mobile computing device 102 with them leaves the home zone, then the Mobile computing device attempts to detect and pair with device 110 attached to the asthma article. If the Mobile computing device cannot pair then an alert is generated that the asthma inhaler has been forgotten. The distance after Bluetooth pairing is also check and should be within 3 meters by the Bluetooth proximity service otherwise an alert is generated.

According to configuration entry no 7, 517, “leave stove on”, when an old person has the mobile computing device 102 with them leaves the home zone, then the Mobile computing device attempts to detect and pair with device 110 attached to a flame and gas sensor monitoring the stove, the Mobile computing device reads the value of the sensor and if flame or gas is detected or If the Mobile computing device cannot pair then an alert is generated to check the stove. A report about the sensor state could also be sent to a third party from device 102 using email or SMS

According to configuration entry no 8, 518, “remember gym clothes”, when the user who has the mobile computing device 102 with them leaves the home zone and in the users calendar indicates gym clothes required on that day, then the Mobile computing device attempts to detect and pair with device 110 attached to the gym article. If the Mobile computing device cannot pair then and alert that the gym clothes have been forgotten is displayed. The device 110 is attached to gym clothes bag.

According to configuration entry no 9, 519, “leave hotel”, when the user who has the mobile computing device 102 with them leaves the hotel zone, then the Mobile computing device attempts to detect and pair with device 110 attached to the bags of the hotel guest. If the Mobile computing device cannot pair with the device 110 then an alert is generated. A calendar setting as per 518 can also be required as an additional condition before the check is done.

According to configuration entry no 10, 520, “Going To Beach”, when the user's mobile computing device 102 begins to detect a multiplicity of geographical points which match the route that has been defined as a set of geographical points that the user follows to travel to the beach, then it is detected that the user is moving to the beach, that the beach route has been entered and the a proximity determination is made by pairing with the device 110 and checking that it is when a close distance in this case within 3 m. Alternatively, if there is a reference to the beach at the end of the route in an email, text or calendar 522 then this could be used to deduce that a person is to travel to the beach at a set time and as soon as transport movement is detected at this time then this by itself of in concert with identification of the route above could be used to detect movement to the beach and a proximity check performed.

According to configuration entry no 11, 521, “Place wallet home”, when the user returns to the home zone as detected by the Mobile computing device receiving location updates from for example global positioning system then a proximity check is performed to ensure that the wallet has been brought back to the house. This is helpful to ensures that a wallet has not been left outside and that the user knows immediately if this is the case to be able to find it before too much time goes by and stolen from where left as one example.

In the above examples, “Beach Route”, “On Bus” and “Not Home” are considered risk zones specified by the menu option 318. In the above examples, “Coffee Shop”, and “Hotel” are considered safe zones specified by the menu option 317 where articles would not be stolen similar to a home zone in terms of safety. The distinguishing feature of a “home” zone is that this is where health safety products are stored over night and need to be taken away from the home when the person leaves and used in the outside world, the “not home” zone.

In another example of the operation of the system, an umbrella article is fitted with an entity detection device 110. Configured in the system is the location of the work place of the user. The user travels to and from work on the bus. When the user enters the bus zone the device 110, the umbrella pairs with the user's mobile computing device and the acceleration on the device 110 measured by the accelerometer 118 or IPS sensors 119 is transmitted to the Mobile computing device and compared with a similar sensor on the Mobile computing device. If after entering the “bus stop” zone or “bus route” (risk zone), the comparison of the accelerations show that there is a difference in acceleration including where the accelerometer measurement on the article measured by device 110 is zero or little while the accelerometer measurement measured by the Mobile computing device is greater being consistent with human movement or bus movement then an alert to the user via the Mobile computing device may be sent to warn that the article may be in the process of being left behind. When the user leaves her work place (safe zone), the Mobile computing device 102 attempts to pair with device 110 attached to the umbrella. If the umbrella cannot be paired with or upon pairing use of the Bluetooth low energy Proximity/RSSI distance measurement service shows that the umbrella is not near the user, then the user is alerted that they are leaving the umbrella behind.

If the article protection device 110 entity detection device 110 connected to a lost article does not contact the user's mobile computing device with a certain time, then if the entity detection device may transmit or receive a signal from any nearby Bluetooth low energy device, for example of another person's Mobile computing device which in turn will transmit a message along with the global positioning system location of this contact to the user's mobile computing device. If the device 110 is further fitted with a internet connection then it may contact the user's Mobile computing device directly.

In some cases, the user may be found to have left the home zone when a Bluetooth signal is received by the mobile computing device from a Home automation or Home assistant device which has deduced the that the user is leaving the house and send a Bluetooth low energy signal to the user's mobile computing device. The Home automation device may deduce that the user has left home when the user asks for their keys, or the address of a location or in other ways indicates an intent to leave the home including also by the home automation or assistant unit interacting with the user's email or calendar.

Typically in the examples described above the article protection device 110 of type entity detection device 110 may transmit or receive wirelessly including responding to the Mobile computing device or transmitting or advertising their article id either all the time or when the device 110 is moved as measured by the accelerometer 119.

In the examples described previously proximity may be considered to be the ability of the mobile computing device to discover an advertising Bluetooth low energy entity detection device 110.

In the examples and embodiments described previously software executes in the processor and using the memory on the mobile computing device 102 and entity detection device 110, also referred as the article protection device 110 to perform the functions described above. The touch screen user interface typical for mobile computing device also referred to as mobile communications device can be used to select region an shapes on the mobile computing device as is commonly understood to those skilled in the art of mobile computing device development.

The Bluetooth low energy (also known as Bluetooth SMART) proximity service using signal strength to estimate distance including by RX and RSSI. The proximity functions above typically use these methods to calculate the distance between the article protection device 110 and mobile computing device 102.

Location Based Services (LBS) which may be used to provide location movement data include,

Firstly, Satellite Based Positioning including but not limited to Autonomous and Assisted Global Navigation Satellite Systems such as GPS and GLONASS

Secondly, Mobile Radio Cellular Positioning including Observed

Time Difference of Arrival and enhanced Cell ID, as well as other radio transmitter triangulation methods

Thirdly, Hybrid methods incorporating the first two methods above.

Fourthly, Control Plane and User Plane session handling such as LPP and SUPL including as supported by Long-Term Evolution (LTE). The LTE communications may including LTE by 4G technology or subsequent similar improved technologies replacing this technology such technology generations which follow LTE 4G.

The mobile computing device, also referred to as mobile communications device may also be a Smart watch or other form factors such as embedded into clothing. Where the mobile communication device has a limited user interface, configuration of information is shown in FIG. 3 may be done on an other device and the setup information communicated to the smart watch or other such device.

In the descriptions above, to minimise power usage, a accelerometer or similar movement sensor as well as wakeup timers and other functionality in the article protection device (entity detection device 110) may be used to activate only when there is movement and or at day time when the articles may be required and thus preventing battery drainage to support communications and or processor power usages when it is not needed.

The distance between the mobile computing device and article protection device is determined by the use of the Bluetooth Low Energy proximity profile. The mobile computing device acts as a proximity monitor maintaining a connection using the Bluetooth low energy communication link with the proximity reporter which is the article protection device. The proximity monitor calculates the path loss by subtracting the RSSI from the power level of the transmission. An alert can be generated with a distance is exceeded or the RSSI value monitored at intervals. If the mobile computing device and article protection device are unable to establish a communications link then the distance is assumed to be infinite.

In the descriptions above, the distance between the mobile computing device and article protection device may be determined by to have exceeded a threshold if the mobile computing device cannot discover the article protection device (entity detection device 110) or communication between the devices is not possible. The described distance check may be performed with a varying frequency from continually by means of a continues established communications link or by periodic connections or polling at configurable intervals.

The term Long-Term Evolution (LTE) may also be referred to as 4G LTE.

The terms geographical area, zones or areas are used interchangeably to describe physical geographical areas of the world.

A sunscreen “roll on” dispenser consisting of a roller dispenser sunscreen with a entity detection device attached whose movement is measured by an accelerometer. The accelerometer can be used to check not only that the user has applied sunscreen but also applied over the skin surface sufficiently. When the larger sunscreen bottle is moved or pumped or the small size bottle is used as indicated by the child pressing the button on it. The child presses a button attached to device 110 mounted on a sunscreen tube when she applies sunscreen.

A window uses a typical security detection apparatus such as a magnet on one side and a reed switch on the other. The reed switch is connected to the entity detection device 110 to enable sensing of the position of the window. When the window is detected to be open (as detected by an open circuit reed switch because the magnet is not in range) then the mobile computing device of the user will be alerted. In the case where the person is not present they will be alerted if as they left the entity detection device 110 was checked and was found to be open, or the last known state was unchecked or opened.

### Second Embodiment

In one embodiment, the proximity determination condition is achieved by data from a Long-Term Evolution (LTE). The wireless communication link between article protection devices and the mobile computing device may consist of an LTE communications link and the article protection device uses LTE network and or satellite based positioning and Mobile radio cellular positioning to determine the article protection device's position. The determined position is then communicated by the LTE communications link or other networks to the mobile computing device where similarly the mobile computing device uses the LTE network and or satellite based positioning and Mobile radio cellular positioning to determine the mobile computing device's position. The physical distance between the two geographical positions of the mobile computing device and article protection device is then determined from the two positions for example expressed as latitude and longitude co ordinates, and if the proximity between the two devices exceeds a threshold, then the proximity determination conditions is satisfied.

In an alternate implementation of the embodiment the positions of the mobile computing device and article protection device may be both reported to a remote server where the above calculation is achieved and then if a threshold is exceeded this information is reported to the mobile computing device.

To minimise the drainage on a LTE enabled article protection device, an accelerometer fitted to the article protection device may be used to trigger reporting of position and general communication from the device to minimise the time when battery is used to communicate or the processor in an active state and not in a stand by mode. This is an acceptable when the article protection device is not being moved then it can be considered to in active and not taken with the user and hence left behind. The absence of a position report or any communication from the article protection device which would occur if the article protection device is not moved meaning that not communications is received by the mobile computing device and so no proximity pairing is achieved will allow an alert to be correctly given to the user as the proximity will be above a threshold and no pairing achieved.

### Third Embodiment

Referring to FIG. 2, The system can detect if an entity such as a bag 200 with bag strap 201 has individual components opened such as the opening of a pocket flap 208 to take items from the inside of the pocket 207 where the opening separated two magnetised switch contacts 206 which are normally kept closed by the magnets. The circuit if completed connecting the components 203, 204 and 205 to the entity detection device 110 by electrical conductor 202.

As an alternative to magnets press studs or other mechanical methods can be used to close the pocket. The circuit if completed connecting the components 206 to the entity detection device 110 by electrical conductor 209. The system can additionally detect if an entity has individual components opened such as the opening of zipper section which conducts 203 which is done by passing a current through the conducting component 203. The zipper tag 204 which conducts can act as a pivot on a potentiometer with varying the resistance 205 between sections 203 along one side of the zipper as it is moved back and forward. The circuit if completed connecting the components 203, 204 and 205 to the entity detection device 110 by electrical conductor 202.

Alternatively Sets of one or more plates measuring capacitance across the opening of the bag 299 may also be employed. A magnet and magnetometer to measure the change in magnet strength from the magnet or alternatively a reed switch between two sides of the bag 299 may also be employed to detect the opening of the bag 299.

The entity detection device 110 in the bag 200, can communicate an alert to the mobile computing device 102 via low power RF 210 such as

Bluetooth energy when movement or opening of the bag occurs as well as the bag being detected to be leaving an area. Additionally the display 114 and audible 115 components on the entity device 110 can create alerts. The bag 200 containing the entity detection device 110 may be monitored by a mobile computing device 102 by according to said previously described monitoring modes.

When the Entity Detection Device 110 detects the bag 299 is opened in any one if a number of ways but not limited to the methods discussed above, it turns on the transmission so that the Mobile Computing Device 102 can see from the fact that the bag 299 attached Entity Detection Device 110 is advertising itself some event has occurred or alternatively the event is known only after the two device pairs and communicate the event. The Mobile Computing Device 102 is configured always, or according to the zone, or at certain times, or always only if a specific item has been taken, or is known to be carried for example from the home that day.

Zones, areas or locations can be defined as geographic locations as well as including trips between locations, and over approximately similar times or lengths of times at different times of day or week. Overtime the Mobile Computing Device 102 can notice trips and also when they come to end by way of final GPS location, the length of trip, acceleration and gyroscope 119 patterns including when the bus stops and it is predicted to be the final destination. Users can also turn on explicitly monitoring when think conditions are higher risk. These higher risk area data can be stored at a remote server for use to determine overall risky areas and share this risk information with other users in a social website manner. The ends of trips and journeys, for example when the user may get off a bus is a risky time for leaving items behind, the time during the time travelling on the train may also have a higher risk of threat of theft.

Presently there is little recourse for a passenger whose bag is illegally opened during travel. In this situation it would be highly desirable to discover who opened their bag. If the bag 299 is opened in the presence of hub 109 and both the entity detection device 110 and the hub 109 can authenticate each other cryptographically or otherwise, for example in the case where the hub 109 is in a secure baggage handling centre, then the entity detection device 110 will cause the attached green indicator 211 to illuminate which is the state after the user closes the bag in the presence of the user's mobile computing device 102 or otherwise indicates to the device 110 that it is in a secure state to be indicated as green. If the bag is later opened in the presence of the authenticated hub 109, then the indicator 211 will change to yellow to indicate to the user and security authorities that the bag has been opened but at a secure hub 109 indicating also the hub's ID and associated staff including mobile computing devices 102 to further allow identification of who opened the bag including time and device 102 proximity information. If the bag is opened without successful authentication with a hub and not in the presence of the user's mobile computing device 102, then the time will be logged and the indicator 211 set to red to warn that the bag has been opened illegally. An alarm 212 may optionally also be configured to be sounded when the user's mobile computing device 102 is not present and/or the bag is in a high risk area. Several alarms 212 may be dispersed at various points on the bag and/or hidden or placed below mesh running over a wide area so that it is difficult to silence the the alarm(s) by covering or damaging them. In all cases, the time duration of the opening of a bag can be logged along with accelerometer movements, allowing a later reviewing of the data if a bag has been damage to ascertain at which point during the trip it was damaged.

In these ways GPS and other location determination, acceleration, time and/or location as well as patterns of these associated with journey which may also optionally be a repeated journey, can then be used to learn when to increase the polling frequency or use any of the monitoring modes as well as potentially as described in monitoring mode bonding can be performed especially some time before, or as soon as when for example, the predicted the bus stop from this said this location, movement and trip information indicates or predicts that the person is about to get off bonding or frequency of polling increased so that the distance between the Entity Detection Device 110 and the entity to which it is attached and the Mobile Computing Device 102 and it's user can be monitored to ensure that during these critical high risk moments when the user is getting up the signal strength is strong and the distance indicated is close to ensure that the item is not left behind and additionally that the acceleration is matched

An additional heuristic that may also be used in addition to the monitoring using location, time, path information is movement analysis using acceleration and gyroscopic detection of movements corresponding to someone standing up as measure from the Mobile Computing Device 102. This can be used as a trigger to check if the Entity Detection Device 110 is also being moved and optionally in a similar fashion indicating that they are both moving together and so the entity is not being left behind.

Acceleration of the entity which is not equal to the Mobile Computing Device 102 and it's user depending on a journey of location may indicate entity such as bag 299 is moving whereas the user staying still. If this is in an area of hazard like an airport then the monitoring mode should be set to ensure constantly higher frequency monitoring using one of the monitoring modes included bonding or pairing.

In each of this embodiment the Entity Detection Device 110 and Mobile Computing Device 102 can be considered to be communication using but not limited to any of the monitoring modes previously described.

In each of these other embodiments the Entity Detection Device 110 and Mobile Computing Device 102 can be considered to be communication using but not limited to any of the monitoring modes previously described.

Zones, areas or locations can have a fixed mobile computing device contact hub 109 which performs the same function as a mobile computing device, but differing in that when the user and/or the user's mobile computing device is absent the hub 109 can relay a detection of entities leaving or moved or in other ways actuated or triggered to the user's mobile computing device if the user and associated mobile computing device is remote to the zone in this way and allow the fixed hub 109 mobile computing device to take over the monitoring for triggers and information from entity devices. These hubs 109 can be useful for example when the user wishes to leave an object with entity detector to watch an entity and/or area.

A hub 109 could also be used to collect and forward information from entity devices that are constantly in range or come and go from being in range using monitoring modes techniques as described including the entity device listening periodically for hubs 109 and transmitting information when a hub 109 is found and/or enough information has been collected, awaking from sleep mode at set times chosen by the user as likely to be able to transfer stored information and listening for a hub 109 or awaking from sleep and transmitting the presence of the entity device to which the hub 109 replies and then a response is sent by the entity device to the mobile computing device to transfer information. Optionally when the user mobile computing device leaves range the entity device can be configured to search for a hub 109. As described, adaptive discovery of the best place and time for entity device and/or mobile computing device to awake or transmit can be adaptive algorithm, learning from previously success data exchanges and also having the Entity Detection Device 110 awake and listen at set times for a hub 109. Additionally, the adaptive algorithm can take different strategies depending on the urgency of the transfer and data storage remaining for example if little storage room remained then transfer may be urgent or if data transfer is required at least once a week then as come near to the time the Entity Detection Device 110 must transfer turn on with more frequency.

As described for the monitoring modes, a transmission from the Entity Detection Device 110 can be initiated by the Entity Detection Device 110 when the signal strength of the hub 109 is below a certain level which still allows depending on the transmission power of the Entity Detection Device 110 the Entity Detection Device 110 to contact the hub 109 and alert it that the Entity Detection Device 110 is leaving range. In the case of a child 132 leaving a play area wearing on his hand an Entity Detection Device 110, the Entity Detection Device 110 can transmit back to the hub 109 when the child 132 is determined by the signal strength to be a certain distance from the hub 109. The hub 109 which may have internet connection, Bluetooth connection as well as SMS and email may then contact the teacher locally as well as parents remotely. Information on who to contact can be in a database or stored in the device.

A Profile can be set for the Entity Detection Device 110 depending on the entity it is attached to and user preferences defining for any entity how much and what activities will trigger for example certain accelerations and/or bag 299 opening alerts. For example, minor movement acceleration of a bicycle lock or lock on a tent can be ignored but if they are consistent over a certain time, or indicates tampering then an alarm may be triggered.

Hubs 109 include, can be located at the bike 150 racks or cages, hotels and hostels, in kindergarten, play parks, and apartment buildings to monitor. Optionally a Camera communicating by Bluetooth could be used also and security guard via server. Initially, a bag 135 (299) may be monitored by a mobile computing device 102 by radio connections 124 according to monitoring modes. However the user 101 can leave 129 the bag 135 in the area 120 within radio range of 109 so that the hub 109 (fixed mobile computing device 102) can take over monitoring the bag and hub 109 which is monitoring the bag can alert 128 the user 101 when remote from the area 120 via the user's mobile computing device 102.

As one example a person could leave a bag 299 or laptop with an attached Entity Detection Device 110 in their room and know that the hotel, hostel, office, hub 109 will tell them according to the type of configuration for the entity such as if the item is moved at all, or over a certain amount, in a pattern according to gyroscope 119 is being moved, as well as if it is opened or goes out of range as shown by the path 125, of the hub 109 and it's area 120 for that room or area of the hotel, or moves as determined by triangulation then the Entity Detection Device 110 could send message to the hotel security staff by contact the hub 109 which is connected to local WiFi or internet. The hub 109 could also contact the user who is remote to the location via internet, SMS, email or other communication methods.

As well as fixed hubs 109, a Mobile Computing Device 102 could be a cheap Bluetooth device placed in your car to monitor for example an entity detection device 110 attached to tools or equipment or sports equipment such as a surfboard 152 on top of a car 151. When the Entity Detection Device 110 detects movement this communicated to the Mobile Computing Device 102 which then contacts the user via internet, SMS, email or other communication methods. Alternatively, if there is no hub 109 in a hotel room again a cheap bluetooth enabled Mobile Computing Device 102 could be placed in the bag 299 and either its own acceleration and/or that of the Entity Detection Device 110 can be used to alert the remote user.

In another embodiment a hub 109 or multiplicity of hubs 109 could be used to protect a child by alerting one or more interested parties such as parent far away, teacher nearby and also the child when the child exceeds or reaches the edge of a perimeter as measured by a reduction in signal strength which is can be considered to have exceeded or be approaching the edge of a perimeter where various known algorithms may be applied to ensure an accurate reading including methods not limited to but including averaging and excluding anomalous values.

The system may use some of the monitoring modes previously discussed including, using a timer to allow the entity device to sleep times of days and optionally days of the week when the device may not be needed, only turning on at other times and listening, and again with an adaptive listening receiving cycle which is of low frequency of less likely times for the entity or child and entity device to enter a hub 109 area. Additionally acceleration of the device can be used to trigger the increase polling at any stage. Additionally, the polling time can be kept at a low frequency until initial acquisition of the entry in the hub 109 as the likelihood of leaving before the device can notice the increased polling rate that would occur after entry is smaller. In these ways the battery life can be extended at times before a entity needs to use ore power to monitor. In addition the system employs a method to auto mate the turning on and off of the device so that again the battery life can be preserved.

Once the entity device moves in range a hub 109 or multiplicity of hubs 109, it assume a higher polling rate that is proportional to increasing distance (closeness to perimeter) from the hub 109 and the risk of the area where the zone is located and the amount of movement.

Triangulation can also be employed when the entity is estimated to be near the edge of a perimeter and require accurate monitoring including detection of movements in paths leaving the area.

Additional hubs 154 can be placed with overlapping areas to the main hub 109 covering the area 120, for example near exits or places through which a child may leave. If additional hub areas 154 are present and they are indicated to the entity device as extra exit markers by a identifier then if the Entity Detection Device 110 detects them as can still detect the main hub 109 then it may bond or frequently poll to check if the distance from the Entity Detection Device 110 to the hub 109 is decreasing while still in the presence of the extra hub 109. If this continues and especially if both the distance from the main and extra hub 109 increase then an alert is generated indicating that the Entity Detection Device 110 is leaving the hub 109 area as shown by the path 157. The extra hub 109 can be used to protect the circumstance for example when there is a door so that an alert is generated if using any of the monitoring modes the extra hub 109 is detected at a certain signal strength and hence distance.

If an Entity Detection Device 110 detects that the user's Mobile Computing Device 102 is leaving an area but there is a hub 109 that can take over monitoring and the Entity Detection Device 110 has been configured to allow this then the hub 109 will then take over monitoring and pass alerts and data to the user who is now remote as well as optionally additionally local users who can monitor. If a child, or entity such bag 299 with attached Entity Detection Device 110 leaves an area however the user (or a group of users) and attached Mobile Computing Device 102 are also within a certain range then an alert may not be generated as the person or entity is considered to be able to protect the person or entity and also know and be supervising the persons departure from a monitored hub 109. Alternatively, the user via the Mobile Computing Device 102 may receive an alert to confirm that they know that the child or object is leaving the area and optionally that monitoring is to be turned off. One or more remote users may also receive a message to let them know that the Entity Detection Device 110 is leaving a hub 109 with a user and attached Mobile Computing Device 102. In addition to the monitoring of children, the system may also be used to monitoring the sick or elderly. The hub 109 and extra can also communicate information and match up data.

In one embodiment, one or more hubs 109 can be placed permanently or temporarily and used to collect information as “hub information collectors” by monitoring entity device either as events happen and are sent immediately if the hub 109 is present onto a server for activities including not limited to logging or alert a third party including when the are not there. As the entity device does not have the ability to connect to WiFi, internet or other such as network connections it can use the hub 109 as the means to achieve this in a energy efficient manner connecting to the hub 109 when it is present using a variety of connection techniques involving techniques such as the entity polling the listening for a transmitting hub 109 with maximum sleep for the entity and listening for a hub 109 transmitting only when only necessary including also accumulating results where possible to limit the frequency of connection as disclosed in this invention description including but not limited to the description for “monitoring mode strategies”

In one method, the entity device turns on discoverable advertising when it has data to transmit. The user suggests a time or the phone learns the time it can contact the hub 109 and when the data transfer is over the Entity Detection Device 110 sleeps between transfers.

An Entity Detection Device 110 with an attached PIR can be configured to be turned on by an Mobile Computing Device 102 when it detects an unsafe time or location.

In some embodiments, the methods described for a bag 299 can be applied to wallets, purses, camping back packs, sleeping bags 299, travel bags 299, lap top cases as well as for detecting if the a person is wear a coat and jacket which is zipped up.

In another embodiment, if a mobile computing device detects that the user has lost GPS or radio signal or gained internal positioning (IPS), then it can make an hypothesis that the user has entered a building, and at this stage it can send a signal to any entity devices to see if there and then when GPS or radio is regained it can check those items are there and prompt the user they may have left them behind. In this way, without geographic lookup or database can deduce locational changes of importance including entering and leaving a building. In some embodiments, a fixed hub 109 can be is used to perform occasional or continuous audit tracking of asset each with a entity device attached. Example assets may include computers, chairs, tools. If someone attempts to move an asset as detected by accelerometer 118 or break a sticker with a wire embedded that breaks a contact switch causing a circuit to be opened and the Entity Detection Device 110 is sleeping waiting for an Input/Output event to wake up and trigger a signal to the hub 109.

Other connections could include magnetise contact switch, loss of pressure between the object and the entity or another other form of switches as widely known in the security field of art. In cases such as theft tracking to track the movement of the equipment where the Entity Detection Device 110 remains connected to the entity but the whole entity is moved the methods described for monitoring a child in areas of safety could be employed. In additional to real time asset checking if it may be sufficient to get occasional synchronise as once a day, week, month. If it is important to regularly establish the location of the object then any of the monitoring modes may be employed and Additionally in a similar way to the monitoring of bags 299 previously described.

When a entity is detected to have been moved or opened then an mobile computing device or local registered person in the office, or a local alarm can be triggered if the person is not there or in addition to the alarm or camera activated in that otherwise or also a remote message for example to a security guard. Additionally an auditor that enters a building a walks through can also transmit a signal, if the devices are designed to listen for the auditor at a time and/or day of week, or have one specific time each week where they listen and can be set by mobile computing device to be ready for an audit at a particular time then this can. In addition to assets in an office this technique could be applied to monitoring goods in a shop against theft. As soon as the objects are moved, the Entity Detection Device 110 may also immediately wake up and start sending updates of their position until they stop moving allow a system to track if their movement is may indicate theft such as by their movement towards the door without passing past checkout. The position of the device can be determined by the calculate of distance by signal strength such as RSSI or other methods using low power RF of one or more receivers or transmitters from the entity.

In addition to monitoring when an asset is moved, it may be important to have an item provide regular updates to prevent a thief Shielding or jamming the signal that would be performed by thief to prevent the warning signal being. In this way the hub 109 can deter something may also be wrong if heartbeats not received. The system should also attempt to scan for jamming signals.

In some embodiments, processing of data can be performed at the Entity Detection Device 110 and/or Mobile Computing Device 102 or distributed between the two devices. In some embodiments, a fixed hub 109 can monitor doors in a building to see if they are opened using magnetic switches, contact switch accelerometer 118s and the like. Changes in states or continuous states of interest such as open long time can be transmitted to the hub 109.

In some embodiments it may be desirable to sense whether a tap in the garden or in the house has been left on by mistake by someone when busy or by an elderly person who is forgetful and have the user or a third party remotely be able to check or receive a warning when this occurs. This would be desirable to prevent water wastage or flooding of an apartment or house. The entity device can sense this using a hall effect sensor to detect the flow of water, accelerometer flow of water by vibration or noise or moisture. The detection of water flow for a certain amount of time or volume determine by the magnitude of the sensor reading or combination of volume and time can be used to trigger an alert to be sent to the mobile computing device or hub 109 from the Entity Detection Device 110. If the person doesn't respond then an alert is sent by a fixed hub 109 in the house to the a remote user.

Additionally, IPS using low power RF triangulation can be used to locate and warn when a person is in the wrong place. The Entity Detection Device 110 communicates to one or more users Mobile Computing Device 102 or optionally also by a hub 109 if present to remote users Mobile Computing Device 102.

In some embodiments, the Entity Detection Device 110 and Mobile Computing Device 102 can communicate with any of the monitoring modes, with a Mobile Computing Device 102 able to concurrently monitor one or more Entity Detection Device 110 as well as an Entity Detection Device 110 be concurrently monitored by one or more Mobile Computing Device 102s, including Mobile Computing Device 102 acting as hubs 109 as well as remote user Mobile Computing Device 102 which receive data and alert from the hub 109 via communication methods including but not limited to internet, SMS, email.

In some embodiments the mobile computing device may be smart devices, smart phones and tablets, smart watches, as well as all kinds of portable computing devices with low power RF as well as optionally able to communicate using other forms of WiFi, mobile network communication, Examples of such devices include but are not limited to devices running iOS, Android and Windows operating systems. The term can also be applied to laptops and may also include desk tops and be broadened to also include fixed computers configurations. Additionally, where mobile computing devices are mentioned as fixed this may included mobile computing devices that are portable in characteristics including size and weight and connection to a network that accessible while the device is moved by has been placed in a fixed, or to some degree unchanging position.

Power to the mobile computing device is assumed to provided from a source that can used to constantly supply the charge or recharge a battery in the mobile computing device.

In some embodiments the entity devices can also include all kinds of mobile computing devices. As one example as smart watches such as iWatch can be taken off and potentially left behind when changing after sport as one non limiting example, The iWatch could operate, including in its application software in a similar way to other Entity Detection Device 110 for purpose of it being protect from loss as described in this disclosure. However the iWatch can also operate as mobile computing device for the purpose of monitoring other entity detection devices.

A smart watch may also act as a mobile computing device. The Power to the entity device is assumed to provided from a battery that is generally small and not rechargeable and needs to be conserved with minimal usage to extend the life of the battery including trying to maximise sleeping time, and receiving as opposed to transmitting time however it could also be considered that it could be connect to a source that can used to constantly supply the charge or recharge a battery.

In some embodiments, the distance between the entity detection device and mobile computing device can be determined by using signal strength calculations using low power RF transmitters and receivers such as RSSI. Low power RF methods may including but are not limited to Bluetooth classic, Bluetooth Low Energy also known as Bluetooth smart and Bluetooth 4.0. In some embodiments, Low power RF methods may including but are not limited to Bluetooth classic, Bluetooth Low Energy also known as Bluetooth smart and Bluetooth 4.0. In some embodiments, the distribution of monitoring and processing of data can be spread to various degrees between the Entity Detection Device 110 and the mobile computing device software and processors. For example, in the case of the monitoring acceleration of an entity detection device which is to be monitored when a the mobile computing device notices the user has entered a new location or area, which requires careful acceleration monitoring to be performed to see if for example a bag 299 is lifted up or moved in a purposeful manner for some reason that the system may wish to deduce, then a software algorithm can be applied to the movement data in either the entity device or the mobile computing device. All algorithms for movements as well as other algorithms for other purposes can be applied in software and/or additional hardware on either and/or both the entity device and/or mobile computing device.

In some embodiments, acceleration, compass and gyroscopic data can be collected from the entity device and/or the mobile computing device and used to determine if certain kinds of movement have been performed such as the purposeful movement of a bag 299 away from a person indicating for example that the bag 299 is being taken away as for example in one instance a possible theft.

In some embodiments, the transmitting of a signal or alert can be achieved by a device advertising and/or making itself discoverable without then need to form a connection. For example, if a bag 299 is opened the Entity Detection Device 110 can sense this then by turning on and advertising it can be considered to have communicated an alert. In some embodiments, the alarm may be of various volumes or visual appearances or battery usages depending on whether the mobile computing device of entity device and also on the power connected. In some embodiments, all known methods can be used to send a remote message or alert from the mobile computing device to a remote such as SMS, data sent by internet, or recorded or live voice and video data. The message sent may include information such as the GPS, Bluetooth beacons or transmitter ID nearby as well a day and time.

In some embodiments, the remote server may include a database, and software to collect and process information according to various algorithms, and be able to contact other users via their mobile computing device including by SMS, data sent by internet, or recorded or live voice and video data. In some embodiments, advantage is provided by prolonging the battery life as this means that the device may use very little battery and so approach the shelf life of the battery or at least long periods of time which match or exceed the stated or anticipated expected life time of the device so that the casing can be arranged in a manner where the battery is permanently sealed to save costs and/or improve water resistance.

In some embodiments, the said monitoring modes can be applied to the warning when a child wearing an Entity Detection Device 110 and a parent with Mobile Computing Device 102 are separated by distance and the Mobile Computing Device 102 using location sensing such as GPS identify that the child and parent are in an area of risk from traffic danger for children. The distance after which an alert is given can also specified and adapted according to the traffic risk in the zone. The child can receive warning on his Entity Detection Device 110 if he is beginning to move away from the parent. The zones can be very specific with distances less than for example 0.5 metre as one example, when right near the edge of a road.

In some embodiments, where many different separate software applications 104 in the mobile computing device 102 are concurrently monitoring such as polling for the purposes of listening and/or transmitting for connections using lower power RF between mobile computing devices 102 and entity detection devices 110, then the software 104 on the mobile computing device 102 can be consolidated or combined or in other ways partitioned in to a separate application or service for the purpose of overall performance efficiency. The said combined application, software or service can call back other individual applications when events occur or on the status of regular polling done on behalf of one or more software applications as well as marshal outputs on behalf of the same software applications. In some embodiments, multiple mobile computing devices 102 can communicate with a single entity detection device 110. In some embodiments, an addition camera can be included with the entity detection device 110 or the mobile computing device 102 and used for the purpose of recording a particular event that is being monitored. In some embodiments, the entity detection device 110 and the mobile computing device 102 can be synchronised to communicate at set times and frequencies using the synchronised clocks and/or timers.

In some embodiments, the sunscreen dispenser 133 is moved or opened then a signal is sent to the mobile computing device 102 so that it knows the sunscreen dispenser was used and does not therefore matter if left behind. In some embodiments, The entity detection device 110 attached to, or co resident to a multiplicity of entities, can communicate an alert to the mobile computing device 102 via low power RF such as Bluetooth energy when movement or opening or a multiplicity of other events occurs as well as the entity being detected to be leaving an area. Additionally the display 114 and audible 115 components on the entity device 110 can create alerts. In some embodiments, allocating rewards may also include allocating negative points for incorrect behaviour or failure to comply.

Alternatively a small indicator on the entity detection device 110 on the cup such as an led could also be configured to be displayed. In some embodiments, the power usage of the entity detection device 110 can be reduced by having the processor, for example, as one non limiting example, the texas instruments cc2540 processor enter a sleep mode with minimal current drawn and have devices such as a MEMs Accelerometer generate an interrupt to awaken the processor rather than have the processor poll the sensors regularly. In some embodiments, the systems described here combining software and hardware may be used at production time to create and ship to customers a fixed product, while in other embodiments the system can be supplied as a configurable or customizable system where the user connects the individual sensors and defines the sensor program 197. In some embodiments, the communication between the entity detection device 110 and other devices 110 and 102, 109 can be done with Bluetooth Low Energy or other low power rf methods, or other rf methods, including WiFi, as well as wire connections or standard wire. Communication between mobile computing devices 102, 109, and servers and other devices can be done by Bluetooth Low Energy, WiFi, internet connections, sms, chat, facebook or other social media communication mediums. In some embodiments, the use of electronic equipment may be monitored by the use of hall effect, magnetometer, or induction of voltage or current in a sensor coil attached to the power cord or other sections of the device from where energy usage can be detected. These sensors are connected to the entity detection device 110 and measure the can be used with a sensor program 197 and sensor detection pattern 196 to detect and alert, or rewards points or negate points based on the measured usages of devices.

In some embodiments, the entity detection device 110 may be attached to critical medical devices such as Inhalers, epi pen, heart medications, pill boxes as some non limiting examples and as described for hats, sunscreen and umbrellas a reminder issued if the user leaves them behind at a particular location or forgets to take them from home. In the case where the medication is for a child and they do not carry a mobile computing device 102, the child may also carry an entity detection device 110 which will check when the device 110 connected to the child and the device connected to the medical device are separated. With the rise in food allergies requiring epi-pens (epinephrine auto injector) and asthma, this method could reduce that chance of a person dying because the device was forgotten. Leaving medicines behind also erodes their effectiveness when they are there fore not able to be taken at the correct times. It is very important that antibiotics not be left behind and by placing a device 110 on the package this can be averted.

In some embodiments, the application software on the mobile computing device 102 checks the location of the user periodically using GPS, Wi-Fi or radio towers as some non limiting examples, to determine whether the user is outdoors, and so potentially exposed to UV radiation, by consulting a database of geographical features identifying areas and locations that are not inside or shaded. The application software records how much time, on which days, at what times, and how regularly the user is in these locations. This information can be used to identifies days and times when the system should monitor for the separation of the user and sunscreen dispenser 133 as the user will be at risk of having no sunscreen on days when it is needed.

In some embodiments, the functions described for the entity detection device 110 may be performed by software and sensors in devices such as mobile computing devices 102, as well as devices such as smart watches, including the iOS based devices such as the iWatch and Android and Windows based devices such as smart watches.

In some embodiments, the hub 109 may act as a Bluetooth Low Energy beacon.

15. A conditional separation alert system, comprising:
one or more article protection devices, each consisting of a low power transceiver where in each article protection device is attached to a separate location sensitive article; and
a mobile computing device having a low power transceiver, a processor, and a memory wherein the mobile computing device is adapted to wirelessly receive location movement data and to determine if any of the location sensitive articles are relevant to the user of the mobile computing device based on the location movement data, wherein the mobile computing device establishes a communication link with the one or more article protection devices, by a wireless communication link, if the article protection device is attached to a location sensitive article that has been determined to be relevant to the user, wherein the mobile communications device determines if the proximity of the mobile communication device and the one or more article protection device attached to the relevant article exceeds a threshold of a proximity determination condition consisting of distance and alerting the user that the condition has not been met.

16. The conditional separation alert system of claim 15, wherein the communication link includes: Bluetooth, Wi-Fi, cellular, Long-Term Evolution or radio.

17. A method of monitoring the location of location sensitive items, comprising:
attaching a low power transceiver to one or more location sensitive article;
using a mobile computing device with a low power transceiver, processor, and memory to receive location movement data wirelessly;
using the processor to determine which of the location sensitive articles are relevant to the user of the mobile computing device based on the received location movement data;
establishing a communications link between the low power transceiver, processor, and memory to receive location movement data wirelessly;
using the processor to determine which of the location sensitive items are relevant to the user of the mobile computing device based on the received location movement data;
establishing a communications link between the low power transceiver of the mobile device and the low power transceiver of one or more of the location sensitive articles that was determined to be relevant to the user;

18. The conditional separation alert system of claim 15, wherein said location movement data is wirelessly received selected from the class compromising: Wi-Fi, global positioning system, radio triangulation, mobile radio cellular positioning, Long-Term Evolution based positioning and bluetooth beacons.

19. The conditional separation alert system of claim 15, further consisting of a database of geographical areas wherein said location movement data is checked against said database in order to detect the transition of said mobile computing device from a first geographical area to a second geographical area triggering said proximity determination.

20. The conditional separation alert system of claim 19, wherein said first geographical area is the geographical area where the user resides and said second geographical area is the area excluding said first geographical area.

21. The conditional separation alert system of claim 19, wherein said second geographical area is the geographical area where the user resides and said first geographical area is the area excluding said first geographical area.

22. The conditional separation alert system of claim 19, wherein said second geographical area is selected from the group consisting of the public transport boarding locations, public transport vehicles and public locations, and wherein said first geographical area is exclusive of said second geographical area.

23. The conditional separation alert system of claim 19, wherein said geographical area consists of a geometric shape selected from the group consisting of one or more circle, square, rectangle and polygons enclosing an area corresponding to a physical area in the world, and wherein said geometric shape is selected on a map representing said physical area in the world by means of a graphical interface on said mobile computing device, and wherein said geographical area is associated with said article.

24. The conditional separation alert system of claim 19, wherein said mobile computing device monitors the movement of a user and identifies one or more geographical areas visited, and wherein by means of the user interface of said mobile computing device prompts the user of said mobile computing device to associate said geographical area visited as a said first or second geographical area.

25. The conditional separation alert system of claim 19, wherein said mobile computing device monitors the movement of a user and identifies one or more geographical areas or paths visited, and wherein by means of a comparison to a geographical database of known geographical features consisting of areas and paths identifies said geographical area or path, and wherein the user of said mobile computing device is prompted to associate said geographical area or path visited as a first or second geographical area.

26. The conditional separation alert system of claim 19, wherein upon the detection of the movement of said mobile computing device along a multiplicity of shared sections of geographical paths known to the system an alert associated with said location sensitive article is generated upon the resolution to only a matching single geographical path.

27. The conditional separation alert system of claim 15, wherein said distance is determined by the Bluetooth pairing of said mobile computing device and said article protection device using said communication link, and wherein said distance is measured by a Bluetooth proximity profile service between said mobile computing device and said article protection device.

28. The conditional separation alert system of claim 15, further consisting of accelerometer sensors attached to said mobile computing device and said article protection device, and wherein said proximity determination condition further consists of the communication of said article protection device accelerometer measurement to said mobile computing device by said communication link, and wherein said acceleration readings are compared, and wherein upon measurement of a difference in acceleration readings exceeding a said threshold an alert is generated.

29. The conditional separation alert system of claim 15, further consisting of a Long-Term Evolution positioning systems incorporated into said article protection device and said mobile computing device, and wherein the geographical position of said article protection device determined by said Long-Term Evolution positioning system is reported by said communication link to said mobile computing device, and wherein the geographical position of said mobile computing device is determined by said Long-Term Evolution positioning system and the distance calculated.

30. The conditional separation alert system of claim 15, further consisting of a sensor attached to said article protection device, and wherein said proximity determination condition further consists of the communication of said article protection device sensor measurement to said mobile computing device, and wherein an alert is generated upon detection of sensor readings.

31. The conditional separation alert system of claim 30, wherein said sensor is selected from the group consisting of reed switch, button, and accelerometer.

32. The conditional separation alert system of claim 15, wherein said location sensitive article is selected from the group consisting of medication, asthma inhaler, ephinephrine auto injector, insulin medication, umbrella, keys, wallet, bag, purse and sun glasses.

33. The conditional separation alert system of claim 20, wherein said first home geographical area is the location where user resides, and wherein said location sensitive article is selected from the group consisting of medication, asthma inhaler, ephinephrine auto injector and insulin medication.

34. The conditional separation alert system of claim 22, wherein said second geographical area is of high theft risk wherein said location sensitive article is selected from the group consisting of umbrella keys, wallet, purse and sun glasses.
